(19) United States
(12) Patent Application Publication
(10) Pub. No.: US 2003/0074331 A1
(43) Pub. Date: Apr. 17, 2003

(54) Method for the determination of economic potentials and temperatures

(76) Inventor: Hans-Diedrich Kreft, Dassendorf (DE)

Correspondence Address: Kevin W. Guynn, SONNENSCHEIN NATH & ROSENTHAL, Wacker Drive Station, Sears Tower, P.O. Box #061080, Chicago, IL, 60606-1080, US

(21) Appl. No.: 10/097,165

(22) Filed: Mar. 13, 2002

Related U.S. Application Data
(63) Continuation of application No. PCT/EP01/07777, filed on Jul. 6, 2001.

(30) Foreign Application Priority Data
Jul. 13, 2000 (DE) DE1003421.3
Dec. 18, 2000 (DE) DE100 6 3058.8
Jan. 7, 2001 (DE) DE10101784.7
Feb. 3, 2001 (DE) DE10105314.2
Apr. 25, 2001 (DE) DE 10129826.9
Jul. 5, 2001 (WO) PCT/EP01/07728

(51) Int. Cl. G06F 17/00

(52) U.S. Cl. 705/400

(57) ABSTRACT

A method is described, with which by use of technical devices TEG the economic data “economic potential V” and “economic temperature T” can be automatically determined for the advantage of deeper analysis of micro economical as well as macro economical processes. Furthermore a method is described, with which the money values of a P-Scale are automatically determined according to the principles of market supply and demand.

This application is a continuation of International Application PCT/EP01/07777, filed Jul. 6, 2001 claiming priority to DE1003421.3 filed Jul. 13, 2000; DE100 6 3058.8 filed Dec. 18, 2000; DE10101784.7 filed Jan. 7, 2001; DE10105314.2 filed Feb. 3, 2001; DE 10129826.9 filed Apr. 25, 2001; and PCT/EP01/07728 filed Jul. 5, 2001. All of the foregoing applications are incorporated herein by reference to the extent permitted by law.

### BACKGROUND OF THE INVENTION

The invention concerns a procedure for the measurement of economic potentials V and economic temperatures T, under help of a technical device TEG for the input, storage and processing of data for the evaluation of economic processes.

State of the Art

To the theoretical background and to the scientific aspects, how they are used in this description, the following documents with copyright of the inventor are present by the inventor:

a) Document D1 (published January 1999): (Thermookonomie, Theorie naturwissenschaftlicher Okonomiemodelle) Thermoeconomics, theory of scientific economic models

b) Document D2 (published December 1999): Y−Ω=VT, (Thermookonomie, Die neue naturwissenschaftliche Dimension wirtschaftswissenschaftlicher Theorien) Thermoeconomics, the new scientific dimension of economic theories

c) Document D3 (published April 2000): Measurement of human knowledge, Thermoeconomics, A new base of economic theories

d) Document D4 (published April 2000): (Thermobkonomie, Ein neues Fundament okonomischer Theorien) Thermoeconomics, a new foundation of economic theories

e) Document D5 (published Jul. 7, 2000): (Thermookonomie, Das betriebliche Humanpotenzial, Neue Methoden der Betriebsanalyse) Thermoeconomics, the human potential of companies, new methods of controlling

f) Document D6 (published Aug. 14, 2000): (Thermookonomie, Humanpotenzial und Wohlstand, Arbeitslosigkeit im Wohistand) Thermoeconomics, human potential and prosperity, unemployment in prosperity

g) Document D7 (published Aug. 15, 2000): Thermoeconomics, Keynesian Formalism in Thermoeconomic E5-Space

h) Document D8 (published Oct. 3, 2000): Unemployment in Wealth: A scientific approach to the solution of socioeconomic problems.

The above mentioned and further documents to this ranges of topics can be received under www.hans-diedrich-kreft.de.

In the above named publications the scientific theory which uses the methods for the determination of economic information and temperature, is called thermoeconomics. Although the economic temperature is determined with the help of the same mathematical methods, as it is used in thermodynamics (physics), the term thermoeconomics has been proved as to weak within the area of the social and economic sciences. The human aspects and effects are not entered therein. Therefore as scientific new term the word Humatics was introduced as a composition of core items from the words “human” and mathematics. In this sense the technical mechanisms and procedures described here use the methods of the humatics.

From the documents D2, D3, D4 can be taken mathematical methods, by which to skills and abilities are assigned an economic information, measured in the unit [bit]-, from which for a complete free-market economy a temperature T can be derived. These documents do not use the concept of the economic distribution. It is not described in them, how to determine for all by money value or cash flow detectable economic goods (thus not only skills and abilities of humans) an economic potential V and how a distribution temperature can be determined. The necessary methods and concepts are for the first time described in the DE 100 34 213.2. There is for the first time described, how the methods are to be used in technical mechanisms and procedures.

Not in D1 to D8 or otherwise is described or published the separation of the economic potential V or potential H into two separate parts with different economic meaning. This is one the objectives of this patent application. So far V, H or T are not used for the analyse of economic processes. If the values of V, H, T shall be used for the comparison of economic processes, which take place at different time and different localizations, there are necessary identical methods and identical comparison data in technical devices. The high effort for computation for the determination of V,H, T can be done by technical equipment.

### SUMMARY OF THE INVENTION

It is the task of the invention to produce these new economic data, to use the data which occur at different times at different places for the analyse and comparison of economic processes. It is a further purpose to determinate the data by defined methods of technical devices and thereby more or less to “standardize” the data whereby a better compatibility of such humatical data are given, which by different methods and possibly different persons are determined.

Purpose of this patent application is it to get by the application of an equivalent procedure and the use of the same reference data with help of technical devices for input, store and process of data, compatible economic data like the economic potential V, the human potential H and the economic temperature T for comparison of economic processes. Furthermore it is for the first time demonstrated, how the human potential H as measure for human skills and abilities can be subdivided into two parts Ha and Hc for the reason of different economic application. Furthermore are applied to the future of economic theory, analysis and modelling additional data (observables) which may be helpful to find new solutions for social-economic problems, e.g. that of unemployment.

The solution of the task relates to a method used in a technical device for the measurement of economic potentials V and economic temperatures T, under help of a technical device TEG for the input, storage and processing of data for the evaluation of economic processes, whereby the technical device TEG uses electronic components for storing and calculating data, whereby

1. the technical device TEG contains electronic components for storing and calculating data,

2. in TEG a quantity L of distinguishable storage areas a1, a2 .. aL are given,

3. whereby to each storage area a1 at least is assigned one identifier X, so that at minimum L identifier X1, X2 . . . to XL are given,

4. whereby by each Identifier X classifiable, economic goods P are additionally marked as products, services, human abilities or knowledge,

5. whereby at least to one storage area ai a number mi is assigned, which is related to a money amount in units of a currency whereby this money amount mi is assigned to a good P,

6. whereby the values of mi are data which are evaluated from reference data of market demand and market supply,

7. whereby in the device TEG the following calculation steps over L identifier at certain times t1 to tn are executed:

a. from L numbers m1 is calculated the total Nsum,

b. to each number mi is calculated a quotient pi from the number mi to the total Nsum, pi=mi/Nsum,

c. to each pi a logarithmic value Id pi is determined and by pi multiplied, to become L numbers of Lgi,

d. from L values Lgi is by addition determined the total V, which is negative,

e. whereby in the case of multiplication of the value V with −1 are given positive values of V and thus positive logarithmic numbers are given,

8. whereby the logarithmic numbers in accordance with their appearance to points of time sequences t1 to tn determine a sequence of economic potentials V, which can be directly displayed at the device TEG or can be transmitted to a remote data process device,

9. whereby economic potentials of goods P become comparable, if the logarithmic numbers are equally determined and counted in identical characteristic units.

Economic goods P are given as products or services, therefore are given in relation to an economic reality, they can be given—as represented in the FIG. 1—as goods such as flour, sugar, water, energy and fuel, they can also be given as economic services like that of a waiter or a telecom company. The goods P can also be related to the skills and abilities of humans. Thus e.g. in recruitment interviews in companies the skills and abilities of people are estimated. If the real, economic goods and services shall be made accessible by a comparative, economic evaluation, they must be categorized in classes. Thus e.g. very different pairs of shoes are summarised in a class of shoes, apples in an appropriate class etc.

If for example very different classes of goods are used by a company as input goods and thereof are produced output goods, often tables serve for the representation of the relations between these goods classes. All goods of a class can be added or subtracted. To goods of different classes this does not apply. Shoes and apples are not addable. In particular in D5 is shown, how to very different, not addable goods classes economic values are assigned, which supply new economic relations and insights. For this purpose it is necessary, to assign identifier X1ln, X21n . . . X5ln to good classes. This is represented in the FIG. 1. This Identifier can be disposal to a technical device TEG with its electronic memory. An individual storage space can be assigned to the individual Identifier X, also matrix organised storage spaces (see FIG. 1, columns Z1 to Z5) can be assigned. Thus at least L storage spaces a1, a2. . . aL, are present in TEG, which are assigned to Identifier X1, X2 . . . to XL. If a number mi is assigned to each storage space, whereby mi corresponds to an amount Mi of currency units, it results over the Identifier X a distribution of numbers of money amounts (see also FIG. 1). The numbers mi are prices, costs which are applied to goods, services, skills, abilities which are classified by X, whereby the money amounts of real economic goods are entered in the TEG.

The mi can also relate to money flux, which are money values per time, is for example an economic period of 1 hour or one month.

In the device TEG the total Nsum can be formed from the numbers mi, it can furthermore evaluated a quotient pi from the number mi to the total Nsum, from pi can be evaluated in the computer a logarithmic value Id pi, which by multiplication with pi gives the result Lgi. The values Lgi can be added to a value V, which is named as economic potential V. The values V are given as negative numbers, since the quotients pi are smaller than 1 and are therefore the logarithms of this pi are negative. If −V is evaluated it arises a positive logarithmic number V. These numbers can be displayed at the TEG. The numbers of V can be generally supplied to electronic data processing. Since the numbers of V were determined in a special mathematical procedure at certain time points, they can be marked by their specific units with their time points of their origin.

Logarithmic units, which are determined in comparable way in the communication science or in physics (Shannon formula, Boltzmann entropy), are indicated e.g. in the communication science in the unit [bits]. Due to this method equality the economic potential V determined here can be likewise indicated to the unit [bit]. With which e.g. the economic temperature (see explanation further below) in the display of the device TEG is given as money (or cash flux) in a currency unit per bit (e.g. [EURO per bit] or [US$ per bit], or cash flux per bit [EURO per (second * bits)].

If V is determined in the described procedure for an evaluated number of skills and abilities, V is referred to as human potential H (instead of economic potential V).

Classification is to mean that e.g. very different pairs of shoes have such a comparability that they can be combined into a countable quantity of shoes. Flour can be summarized in a class flour etc. In a second step to the classes are assigned monetary values by reference to technical units such as KWh or m³ (e.g. 3 kg flour, 7.84 KWh etc.) or also assigned by reference to simple amounts of pairs of shoes, number of bags etc. In this sense also human learning services are classifiable. As humans must fulifill e.g., the same conditions for the acquisition of a driving licence, driving licences are classifiable. The value of classifiable, human learning service is determined by social or economic agreements or by supply and demand, what is described by FIG. 3.

With the different indicated sources the concept of the economic distribution is presented, which enables the same mathematical operation of economic goods and human skills and abilities. In an economic distribution (see e.g. FIG. 1a) distinguishable classes of goods are represented in the “X-axis” and their monetary values are represented in the Y-axis. Q-distributions are comparable to bar charts, which do not present commensurable goods on the “X-axis”. The two-dimensional form of a Q-distribution serves only for visual illustration. A mathematically more correct representation is given in a mathematical space, which contains so many dimensions, like incommensurable goods (skills and abilities) by distributions are given (e.g., in FIG. 1a is given a 5 dimensional space, in which the distribution would resemble a “hedgehog” with the outstanding beams as pricks).

If different classes of goods for example are present for a company as input goods and from which are output goods produced, often tables serve for the representation of the relations between these classes of goods (FIG. 1). Economic values V, H, T can be assigned by the here described procedures to the values of this tabled

For the technical purposes of storage and comparability it is necessary to indicate goods classes, also skills and abilities by Identifiers. Identifiers are letters and/or number combinations, which are assigned uniquely for a good or service. In the technical device TEG the Identifier X1ln, X2ln . . . X5 determine electronic memory spaces. In the FIG. 1 the rows for flour, energy, gasoline, sugar, water are characterized by Identifiers. To the identifier can be assigned a single storage space or it can assigned a matrix like arranged storage space ai (see FIG. 1, Identifier X^{1ln} . . . X₅ₗₙ for the rows with the columns Z1 to Z5). An identifier X, is in such a manner a substitute symbol for a memory, in which data for a class of goods or services are to be stored, with which different goods, 0.4: services, skills and abilities in a technical device are uniformly allocated. Thus L storage spaces a1, a2 . . . aL are represented at least in TEG, which are marked by the Identifier X1, X2 . . . to XL. If each storage place is loaded with the number mi, whereby mi is referred to as a money value or money flux in units of a currency or money flux as money supply per time (per economic period) the storage space corresponds to a distribution of money values m over the identifier X. In such a manner in a TEG are assembled money values of real economic goods, services and skills and abilities.

In one arrangement of the method the economic temperature T is determined as quotient from the total Nsum divided by the economic potential V (T=Nsum/V). For the explanation of this arrangement it has to be known that T can be determined from the total Nsum of a distribution divided by the value V. T is to be counted in units of monetary values or cash flux per logarithmic unit and is referred to as economic temperature, here distribution temperature.

In an embodiment, for the alignment between supply and demand it is

1. to the by L identified storage areas ai additional to the mi a further number hbi assigned, which is related to an amount of humans, which possess the by Xi indicated skills and abilities,

2. whereby by the processor of the TEG in sequential time intervals at or at optional time points t1 to tn products aωi of pairs of numbers ami, ahbi are evaluated by aωi=ami*ahbi,

3. whereby the total of all L products aoli is calculated as summative monetary supply value Q in the device TEG, 4. whereby into the TEG over data inputs to the □t or the t1 to tn at least one new number bhbj or bmj is combined to a pair of values bhbj, bmj as demand data for a by Xj defined skill or ability,

5. whereby at least one pair of data ahbi, ami is replaced by the pair of data

bhbj, bmj, so that a new product bωj=bmj*bhb results,

6. whereby all not replaced products aωi ami*ahbi are to be modified with their ami in such a way that the total Q remains constant using the new product bωi=bmi*bhbi.

It is described a device determined method for the calculation of a table (named in the writings P-Scale) in which table economic goods (here skills and abilities) are listed and by monetary values evaluated, whereby supply and demand determine the height of the monetary value. The alignment of supply and demand can be fulfilled with the help of a technical device TEG. The claim describes the calculation method for a P-Scale in an electronic data-processing system TEG. The P-Scale is given as a set of data (as table), where the single values are computed again after certain time intervals it or at freely selectable time points t1 to tn. If new data bmj, bhbj of the TEG are given from remote data processing systems, the TEG determines sequentially the mi-values of an updated P-Scale. If the Identifier X are assigned to classifiable, human skills or abilities, the new adapted values are sequentially calculated in relation to supply and demand for skills and abilities. In each storage area ai a number ami is contained, which corresponds to a money value in a specific currency. The number ami represents the supply value of skills or abilities. It represents for the P-Scale the actual money value by which a skill or ability of humans is offered (for example humans will get the money value for a tested skill or ability). This supply value represents the actual value which is to be reset by a new input. Likewise a number hbi is contained in the storage, which corresponds to a number of humans, with which is present a certain ability or skill. The number hbi represents thus a number, which indicates the frequency, with which certain skills and abilities appear with humans.

With processor unit of the TEG it is calculated sequentially the product of the numbers ami and ahbi and is calculated their total Ω. Is a product bmj* bhbj changed, the unchanged products ami*ahbi can be modified in a way that the total Q is evaluated again. The device TEG has input ports for the data hbi, mi. These data are subsets of the data which are present in the TEG. In the simplest case only the money value of an ability or a skill is received again. The incoming demand values are needed for the calculation of the new supply values. For the computing method it is assumed that there are values Q, which remain constant during a larger period, thus at least some Δt-intervals.

For the adaptation of the mi are different program algorithms conceivable. In the case described here it concerns the adjustment of a linear set of equations. In the simplest case a new value (e.g. nm1) is set into a linear system of equations (in the place of the product products ami*ahbi) and all further values mi are again calculated, so that the total of all products remains Q unchanged.

As data sources for supply and demand are interview data in companies can serve. There skills and abilities are evaluated by salaries. Employees agree to the demand or reject to them. Over data-processing systems these data of the companies can feed the device TEG.

The procedure is represented in a simple example. For the elucidation of the principle only two abilities are used. Whereby it is assumed that from the pairs of numbers ahbj, amj only the demand value bmj changes. The first ability is that of Chinese speaking (e.g. in the tested form of a basic certificate CH-A, the identifier could be e.g.: X-CH-A) and the second English speaking (tested in the form of a basic certificate EN-A). Assumed, of thousand humans the number of hbEN=997 have the certificate EN-A and three humans hbCH have the certificate CH-A. If the certificate EN-A is evaluated with mEN a=100 EURO and the certificate CH-A with mCH a=1000 EURO in the P-Scale, it arises as the value of the supply for skills and abilities: Ω=997 *100+3*1000=99 700+3000=102 700 EURO. In this situation a company which is looking for employers announces that it is ready to pay for the certificate CH-A 1 500 EURO. As a new value of the supply market arises: Ω=102 700=997*X+3*1 500. From which arises for the certificate EN-A as a new value 98.95 EURO.

It is to be assumed that in relation to this changed evaluation some additional humans will decide to learn Chinese. From this follows that after some time the value for this ability would sink.

In an embodiment, L identifier La, Lc can be divided into groups, at least in two, whereby a part of the L of storage spaces a1, a2 . . . is assigned to the group La and another part to the group Lc. Thus can be determined in a TEG with V, Va, Vc at least three values for the distinguishable quantities of identifiers L, La, Lb. The values T, Ta, Tc are assigned to the V, Va, Vc.

The purpose of the above separation is to be clarified by the example of the human potential H. Companies need certain compositions of skills and abilities of employees in order to achieve their targets and purposes. This group of skills and abilities are characterized by La (actual needed skills and abilities, applicative skills and abilities). Employees (e.g. employee Eg) have often additional skills and abilities, which are characterized by Lc (capacitive, interpretive skills and abilities). The human potential can be separately determined by Ha, Hc for the two groups of La, Lc. For economic analyses it is of importance to separate the human potential into the actual needed part Ha and the part Hc which is additional available. The part of Hc represents a measure for the skills and abilities, which are available for a co-operation (or a national economy) for adjustment to new competitive situations. With this separation it is favourable to use the methods of complex number calculus (i.e. the use of the imaginary number of i).

In an embodiment, the values hi, mi or further values, which are given by above method can be available in devices, which serve for the composition of accounting data or for controlling analyses. By the computational combination of the values hi, mi or further values with the different bookkeeping and controlling data, it is possible, to determine mathematically the many data sets for controlling which are given in the formulas in the appendix.

The values hi, mi, T or further values, which are evaluated in accordance with the above methods, can be available in devices, which serve also for the determination of macro economical data or macro economical analyse, so that computational combinations of the values hi, mi, T or further values with the different company data and macro economical data are possible. Thus for example the human potential of the persons which are in education can be compared with that of the persons in production, different national economies can be compared and there arise new economical indicators such as stability, effectivity etc. (see literature). In the long run data which are collected by the method of the applied patent e.g., the economic temperature can appear on indicating panels according to the requirements how it applies to share index e.g., to stock exchange courses. All these data are determined by supply and demand. The procedure described here uses comparable principles whereby a specific calculation is used.

In an embodiment,

1. the calculation steps in the device TEG in different devices TEG-A1 to TEG-AX in different memories R-A1 to R-AX can take place at different times,

2. so that different values V-A1 to V-AX are given, which are formed from the values L-A2 to L-AX, X-A1 X-AX available in the devices TEG-A1 to TEG-AX with the related storage spaces ai and values mi,

3. whereby these values altogether or in parts are transmitted to one of the devices TEG-A1 to TEG-AX and there are stored in a joint memory R-U for further processing,

4. whereby the values from the devices in the memory R-U are arranged to groups R1 to Ri on which further calculation steps are applied for achieving uniformity of the values V-A1, V-AX.

With this requirement can the procedure in different devices, in different memories, which can be understood as mathematical spaces, and at different times be applied. Thus are resulting different values V-A1 to V-AX available in the devices TEG-A1 to TEG-AX, which are combined with the different memory places. These, in the different devices available values can be transferred to one of the devices TEG-A1 to TEG-AX and there they can be available in a joint memory R-U for further processing. In the memory R-U the values can be assembled groups of memories or groups of values R-1 to R-i assembled, to which further procedure steps are then applied for generation of new data.

With the above described, technical procedures the principle of the economic spaces is technically used, which is described in the aforementioned writings. The memory spaces of the different devices are understood as sub-spaces, which are combined to one complete space of one device. In particular from the mathematical relations it results that the individual values, as they were determined in the separated devices can be assembled not easily by addition to a total value.

In an embodiment, in two separate devices or storage areas different values V can be determined, whereby these values can mathematically be transformed into each other (mathematical transformation), whereby

1. in two different devices or memory elements TEG-A1 to TEG-A2 the determined values Nsum-A1, Nsum-A2 give the value k by dividing Nsum-A1 by Nsum-A2,

2. whereby in the device TEG-A1 the value V is given by V-A1 and in TEBG-A2 the value V is given by V-A2,

3. whereby in the device TEG-A1 the value V-A2 is calculated by the available value V-A1 by use of the value k,

4. whereby in the device TEG-A2 the value V-A1 is calculated by the value V-A2 by use of the value k.

Also the reciprocal value of above division can be used. As transformation formula is to be applied: V-A1=(V-A2+Id k)/k. It is between two V-values, which are referred to different bases of sums M firstly to form the quotient between the two sums (here sum Nsum-A1 and sum Nsum-A2) with which k results. Only this value k is necessary, in order to transform the one value into the other. In such a manner it is possible to calculate e.g. in a smart card the H-value from the in money units evaluated skills and abilities of a person. If the individual m-values are subsets of a more extensive quantity of m-values, a conversion of the V-values (or H-values) can take place between both quantities, if the sum values of both quantities are known. Details are to be found for this in the indicated book “Das Humanpotenzial” (“the human potential”).

There are well-known devices likes “scanners”, which read in data directly from paper. If such a reader is integrated in a TEG, this device can read table data. By the described method values such as V or T can directly be formed by the device TEG. For this purpose the money values which are assigned to good classes and service classes must be present in a tabular form (see FIG. 1) on a data carrying medium DM (e.g. paper).

In many devices SC which are transportable used by humans (e.g. smart cards, mobile telephones, pocket computer, notebooks . . . ), microprocessors are contained, with which values V, T can be determined. The devices have frequently own energy supplies (e.g. mobile telephones). In addition, there are well-known smart cards, which are supplied by a terminal by contact or contact-free (energy and data are transmitted over coils). The devices are in all cases able to transmit bi-directionally the L identifier X and the data mi, the value T over contact-suited or over contact-free galvanic interfaces to terminals, switching panels, radio towers, to satellite etc. for connection to further technical devices. Likewise those devices are able to receive values V, T from other devices. They are also able to adjusted themselves with a device TEG-cal (see description to the diagrams).

In an embodiment, for the purpose of the comparability of the values V, T between different TEG devices a specific coding for each identifier X is presented in a device TEG-A. The coding can be used by further devices TEG-A1 . . . TEG-Ax, so that classes of economic goods or services are assigned to the same coding in the different devices TEG-AL . . . TEG-Ax. The coding can correspond with those, which are used as bar code for the indication of goods in stores, it can also be used free selected, unmistakable coding for classes of goods and services.

The monetary values of products and services in the economy are often given in relation to technical units such as a KWh or square meter. If in a device TEG-Cal to the coded identifier X are assigned technical units Ui, to which are assigned money values mU, economic goods and services, which are provided with technical measures gi (e.g., 3 kg of apples, 7.84 KWh etc.), can be determined with their economic money value mi. Thereby the device TEG-Cal is suited to assign to all coded Identifier X money values mi by the measure gi and the money value mU. With this assignment are given calibrated values Vcal and Tcal in the device TEG-Cal. With these values classes of goods and services are comparable in its V-values and T-values.

If many TEGXY are connected to a device TEG-Cal by a communications network for data exchange, the devices TEGXY can calculate its values V, T by the same method as it occurs in the device TEG-Cal. A company at location OA can by use of this method compare its local values V, T with the calibrated values in the device TEG-Cal. As the local prices, costs of specific goods can quite much vary, there is given a reference base in the device TEG-Cal.

With input of goods in stocks the Identifier X of the goods are read in by a first technical device TEG-1 at a first place OA-1 (e.g., the stock location). This can be done e.g., over electronic parts (chips), which are connected at the goods. The money values mi are present at a different technical device TEG-2 at a second place OA-2, whereby in one of the devices TEG-1 or TEG-2 or a further device TEG-3 the values V, T are determined.

In companies many classes of goods and services can be subdivided in input or output categories, whereby the output categories depend causally from the input categories. The identifier X can therefore be assigned in companies to the goods, which are disposal as input goods to the company and which are needed for producing the products Y which can be sold. From the Identifier assigned to the input goods can be determined values V, T by the described method. In an appropriate way the Identifier X can in companies be assigned also to the goods, which are counted as sales products Y among the output of a company.

For the comparability and avoidance of cost of computation in external devices it is useful to use a comparable base for the different values. This occurs, if in the device TEG-Pscl in a memory space R-Psclh to each of L identifier for economic goods (also human ability or skills) is assigned a value Lgi (also as hi abbreviated) according to claim 1 (i.e. application of the Shannon formula). For this purpose over L Identifier the total Nsum is calculated, whereby to each number mi the quotient pi of the number mi to the total Nsum is determined, form the quotient is calculated the logarithm and multiplied by the quotient for weighting. The in such a manner determined values Lgi (hi) are stored and are accessible at different times to other devices TEG-A1 to TEG-AX with its different memory spaces R-A1 to R-AX. I.e. these devices can access electronically to the distant memory in the device TEG-Pscl, so that in the devices TEG-A1 to TEG-AX the values hi, mi are identical to those in the device TEG-Pscl.

The values hi, mi or further values, which are calculated by the method, can be used in devices for regulation or control in automatic control loops or control circuits. For example the reserve total in a company can be done by automatically transaction in relation to the human potential of the company.

Humans can combine their human potentials and determine under consideration of tasks different values of it. The values hi, mi or further values, which are calculated in accordance with the above method, are to be grouped in request of tasks, so that specific abilities and skills which are assigned to specific identifier are assigned to certain tasks. For this purpose mathematical methods under use of complex numbers are suitable.

The input ports for the data bmi, bhbi of the device TEG can be performed as network for the transfer of data, whereby at the one side the device TEG is positioned and on the other side a multiplicity of external computers are installed and whereby the external computers supply to the TEG the new data bmi, bhbi. In the device TEG are available computing algorithms, which sort the incoming data by time marks and calculate them. The input channels for the data bmi, bhbi of the device TEG are performed as network for the transfer of data. On the external side are many computers, which supply the TEG with new data bmi, bhbi. The external computers are installed e.g. at companies and supply over the network data to TEG, for example language procedures. If the TEG can process their calculation steps only temporally and successively, new data bhbi, bmi can be present during the processing of a function. In this case the TEG can arrange the incoming data e.g. according to the sequential input or As according to the sequential sending off and consider the calculations of data in the order of their temporal relations.

### BRIEF DESCRIPTION OF THE DRAWINGS

FIG. 1 shows a symbolic indication of economic goods and services;

FIG. 1a shows a distribution representation of different goods;

FIG. 2 shows a distribution inseparably assigned to a person;

FIG. 2a shows a distribution for skills and abilities of a person;

FIG. 3 shows a potential scale, i.e., comparison scale to the evaluation of skills and abilities; and

FIG. 4 shows a symbolic representation of the production of a P-Scale (potential scale) in the device TEG.

### DETAILED DESCRIPTION OF THE PREFERRED EMBODIMENTS

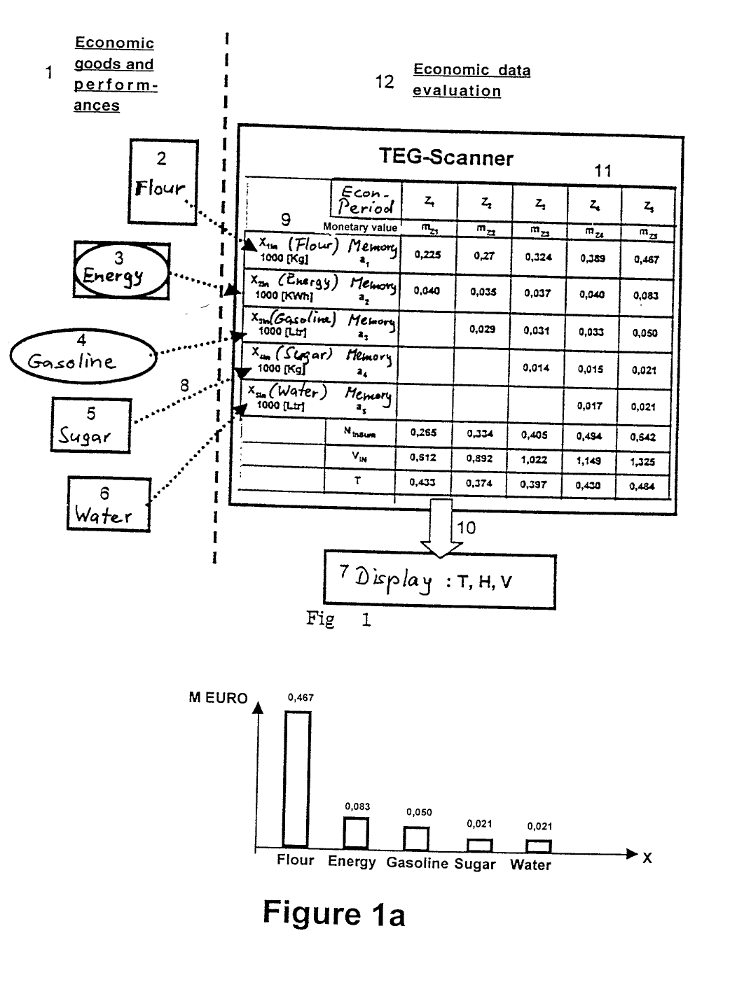

Description of FIG. 1: With 1 the economic goods and services are symbolically characterized, which are indicated on the left side of the broken line. It concerns exemplarily with products which are needed for the production of pasta, e.g., flour 2, energy 3, gasoline 4, sugar 5, water 6. On the right side of the broken line is represented the electronic data evaluation 12, which is to be executed by device 11 as TEG-scanner. The goods 2 to 6 are assigned over dotted arrows 8 to identifiers X1ln to X5ln, which are contained in the column marked by 9. Storage spaces a1 to a5 are assigned to the identifier X1ln to X5ln. Further storage spaces are contained in the TEG scanner, which is symbolically represented by the columns Z1 to Z5. These columns can be assigned e.g. to different years, economic periods. In the columns monetary values mz1 to mZ5 are assigned to the identifiers Z1 to Z5, of which some exemplarily indicated as values. The lowest lines are marked by NlnSum, VIN and T. This are the values Nsum, V, T which are determined in accordance to the described method. Next to each other in the lines are resembled the values f.e. T which are determined in accordance to the described calculation method and which correspond to the different economic periods Z1 to Z5. These values can be supplied to a display 7 over the output channel, interface 10 or be transferred to other devices.

Description of FIG. 1a: FIG. 1a represents the distribution of the column Z5 of the table in FIG. 1. The incommensurable classes of goods flour, energy, gasoline, sugar, water are represented as X-values, money values, factor costs, are represented as Y-values.

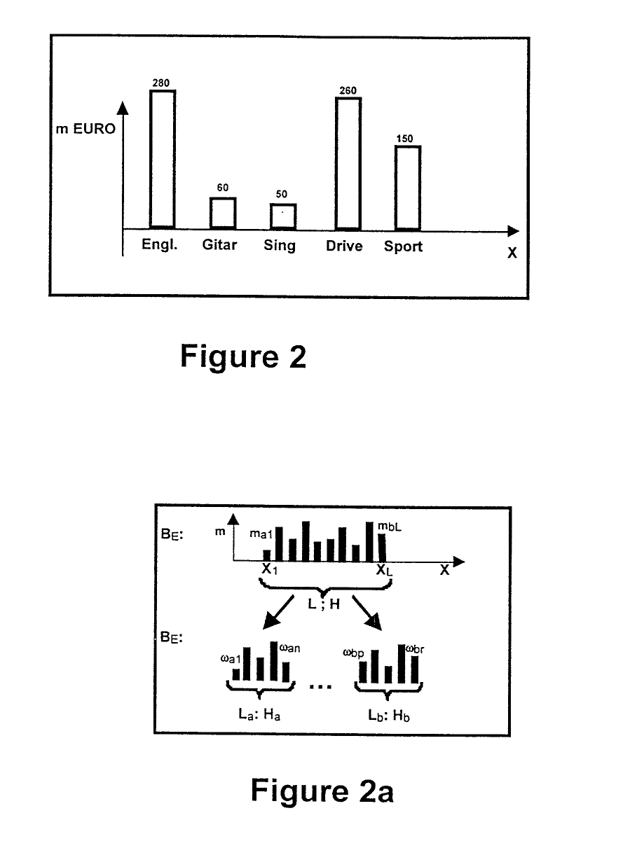

Description of FIG. 2: In the top of the figure is given a distribution which is inseparably assigned to person. The money values of this distribution, ma1. . . man . . . mbp . . . mbr, are assigned to L identifier X1 . . . XL. From the values of this distribution a value H is to be determined. If L abilities are separated into the two groups of La, Lc, two distributions can be separated to which the values Ha, Hc are assigned. The La can be identified as the skills and abilities for which are looked for by company, while the Lb consists of the further abilities on which a person has access.

Description of FIG. 2a: It is indicated a distribution for skills and abilities. The incommensurable class of abilities English course, guitar competition, singing course, driving licence, sport activity are given as X-axis, the related evaluations, like EURO or $, are given as Y-axis.

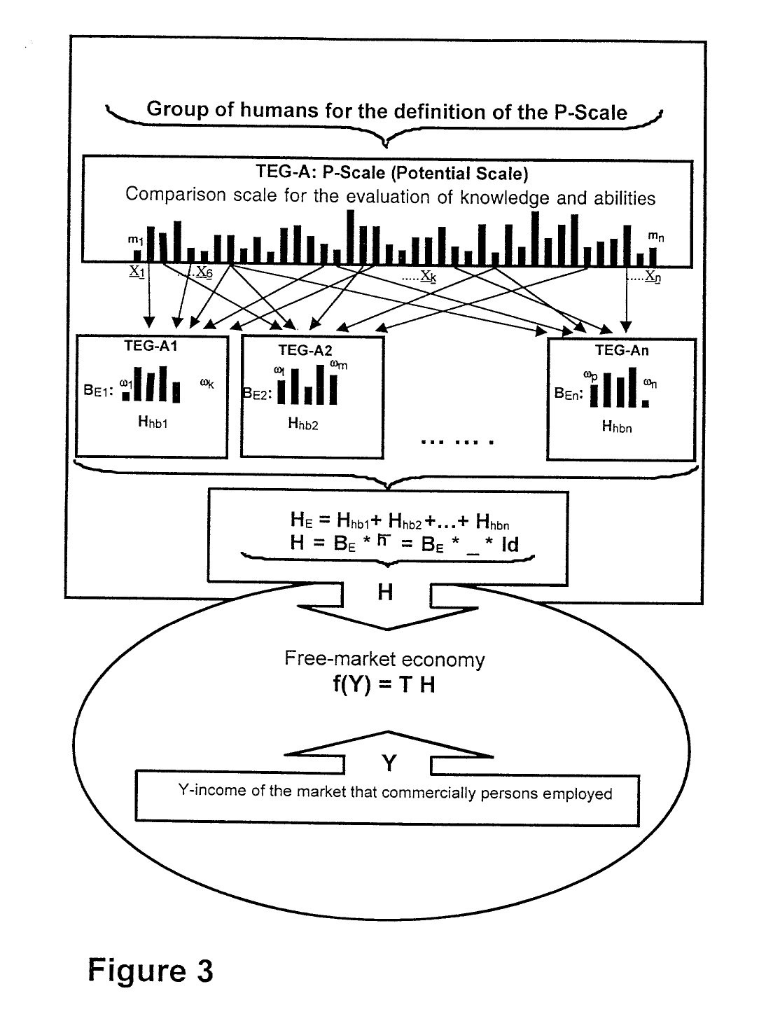

Description of FIG. 3: FIG. 3 symbolizes a scale (table, mentioned here P-Scale) for the standardized use and evaluation of human skills and abilities. In the top of the figure it is symbolically indicated that a committee determines the composition and the values of all skills and abilities of a P-Scale of humans, there are all identifiers with their related money values are determined. This committee can be determined in free market oriented societies in the same way, how it is practised for pay negotiations. The determination of the value of skills and abilities is for a society a likewise important function, as it is for the tariff agreement for hourly wages or for serving human labour. Finally the appointment of hourly wages (salaries) is nothing other than it is the tariff determination of a value for the labour needed in the economic competition. These demanded labour are after the above remarks to FIG. 2 identical to the part La of the skills and abilities of humans B. So e.g. the value for a driving licence course can be set by mF=200 EURO (assigned Identifier for example: Driv00B02.6.004.atx$0200), the value for an English course mE can be set by 270 EURO (Identifier: EOOA12.10.006.atx$0270). The English speaking LKW driver BLKW would receive therefore at least the tariff wage which corresponds to the competition value of these two abilities. At the same time the person BLKW could have sportive and artistic abilities (e.g. proof of regular sportive activities and successful participation in a guitar competition). Although these skills and abilities do not have a current meaning for the economic labour of truck driving, they can nevertheless represent a substantial meaning for individual humans and in addition, for the entire society. Finally sportive and artistic active humans might be in average physically and psychologically healthier than beer drinking chain smokers in front of the television.

The P-Scale is available as database in a device TEG-A, which can be represented as one single (or several together communicating) computers. With the individual bars are characterized the monetary values ml to mn, which are assigned to the identifier (X1 . . . X6 . . . Xk . . . Xn) for skills and abilities. The values of the P-Scale can be renewed at certain dates (e.g. with each beginning of the month) in accordance with the social preferences by the committee responsible for it. The different devices TEG-A1. TEG-Ax obtain its specific values to suitable to their selection of identifiers by alignment with the P-Scale in the device TEG-A. This can e.g. done by means of a mobile telephone in which a group of identifiers is contained, and which takes automatically the appropriate values m from the device TEG-A. It is in such a manner ensured that e.g. a H-value calculated in the Mobilphone represents an actual value for the indication of a group of skills and abilities. From the many H-values (Hhb1, Hhb2. . . Hhbn) can be assembled by addition (HE=Hhb1+Hhb2 . . . +Hhbn) new H-values, which represent a group of humans (e.g. for humans in education). These assembled h-values can in a free-market economy be combined with the values of the goods and services f(Y) sold under competition. The value f(Y) (national income from commercial activity as part of the gross national product) characterizes the success of the commercial active humans of a free-market economy. This free market success f(Y) is set in relation to the education success H (in the oval encirclement of the FIG. 3): f(Y)=T H. The porportionality factor T can be interpreted as the economic temperature of a free-market economy. Since f(Y) has the unit of a money flux (money supply, which changed its owner in an economic period for purchasing of goods and services: e.g. [EURO/year]) and H the unit [bits], the economic temperature is measured in the unit money flux per bit: [EURO/year*bits].

The economic space R_{eco} is spanned by the goods and services X₁, to which monetary values m, can be assigned. Thus the dimension of this space is determined by the number L of the different goods and services. The total M of the monetary values mi of the R_{eco} is given by:

$$M = {\sum }_{i = 1}^{L} {m}_{i} \qquad Formula 1$$

The money supply M can be interpreted as the global, the m, as the local money potential of the economic space. M is e.g. for the pairs of shoes in a shop window with X₁=100ε, X₂=150ε, X₃=50ε to calculate by M=300.

The axes of the economic R_{eco} are represented by different goods and services X₁ (apples, shoes, televisions, trunks . . . ), the comparability of the axes are given by money potentials m. If a money flux (i.e. money flux e.g. by sales of shoes) is realized, the monetary unit (e.g. EURO) changes to the dimension of money flux (e.g. Euro/year). The money value m, has changed to the money flux ωᵢ. From this follows, if the mᵢ (or M) are changed by a factor (here by the dimension factor 1/year or by any other factor e.g. λ·mᵢ with inflation or changed with currency relations), the numbers at the space points are changed to λ·mᵢ. The local monetary values m, therefore are not suitable to indicate a scaling free (free of factors, dimensions) characteristic of the economic space. For this reason humans might set for purchase need prices in relation to other sums of money e.g. such as income, savings balances, turn overs, expenses, purchase sums. The same applies to enterprises, public expenditures etc. Mathematically the influence of a scaling (a dimension factor) can be removed by division (relation to another number). For this purpose is introduced as relative money potential the quotient p₁:

$${P}_{i} = \frac{{m}_{i}}{M} = \frac{λ {m}_{i}}{λ M} \qquad Formula 2$$

The relative money potential pᵢ results in accordance with the above definition from the relation of the local money potential m₁ to the global money potential M of the toal space. The reciprocal value of p₁ is called reciprocal, relative money potential:

$${q}_{i} = \frac{1}{{p}_{i}} = \frac{M}{{m}_{i}} = \frac{λ M}{λ {m}_{i}} \qquad Formula 3$$

If the global money potential M is assembled at one point, results the maximal, relative money potential of:

$${q}_{i} = \frac{M}{M} = 1 \qquad Formula 4$$

For the pairs of shoes in the shop window the following reciprocal, relative money potentials result:

q_{X1}=300/100=3,q_{X2}=300/150=2,q_{X3}=300/50=6 Formula 5

The Dynamisation of the Economic Space

The reciprocal like the relative money potentials (e.g., for the shoes in a shop window) are static. Are the q₁ (or m₁) to be transferred into another economic space (e.g. that of the money flux), they must become dynamic, i.e. during a time interval □t must appear the q₁, to pᵢ (or mᵢ) as dynamic values in a data exchange channel (general data processing system). This channel must posess such a capacity that the minimum value mₘᵢₙ, as well as the maximum value mₘₐₓ can be transmitted. From the following considerations a characteristic number for each channel arises, the amount A of the possible arrangements of all values between mₘᵢₙ, mₘₐₓ, (entered, scanned, measured, reminds.) which are to become transmitted. For the example “shoes in the shop window” can be indicated first all combinations of the money potentials for two single shoes (X₁, X₂), from those then the combination number for three pair of shoes arise. For the two pairs of shoes X₁, X₂ arise:

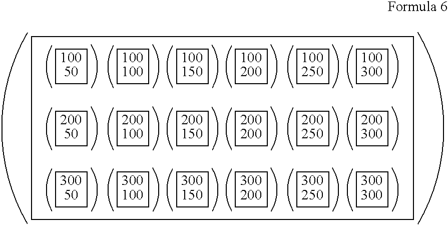

The number of lines of above arrangement is obviously identically to the reciprocal, relative money potential q₁=M/m₁=3, the column number is identical to q₂=M/m₂=6. If the third pair of shoes X₃ is added, again q₃=M/m₃=2 elements are added to each pair of the above arrangement. Thus a channel with A=3·6·2=36 is characterized in this example. This channel is at a max. transfer rate of 300 able to transmit all number combinations of the money potentials of the three pair of shoes. A channel (general: data processing system, e.g., also the human brain) must thus with the dynamisation of an economic space be ready to a maximal number of transmission elements of A, given to:

$$A = {q}_{1} * {q}_{2} * … {q}_{L} = \frac{M}{{m}_{1}} * \frac{M}{{m}_{2}} * … * \frac{M}{{m}_{L}} = {\prod }_{i = 1}^{L} \frac{M}{{m}_{i}} \qquad Formula 7$$

The above product A is called economic channel characteristic. A can be regarded as a measure for the dynamisation of an economic space. From the channel characteristic A can mathematically be derived by use of logarithm (here Id: binary logarithm to the base 2) a addable number:

IdA=Id(q₁·q₂· . . . . q_{L})

IdA=Idq₁+Idq₂+ . . . . +Iq_{L} Formula 8

With thus addability two aspects are fulfilled: If one point is added (a product X with local money potential m,) to the economic space also IdA has to be add by one number. This approximates human thinking habits. At the same time indepencey of scaling is achieved by the quotients q₁ or p₁. In above example it is assumed that the three pair shoes are sold (e.g., in the unit US $), i.e. lead to a money flow Ω=ω₁+ω2+ω₃ and that additionally a further pair fo shoes with ω₄=10 US $ were sold, the new value IdA calculates to:

$$\begin{matrix}Id A = Id3 + Id4 + Id6 + Id30 \\ = 1.58496 + 1 + 2.58496 + 4.90689 \\ = 10.0768\end{matrix} \qquad Formula 9$$

If in the above formula for the evaluation of Id A the single elements are weiht by the pᵢ=m₁/x=1/qᵢ in relation to the global money potential M, results an average value for IdA,:

V=p₁Idq₁+p₂Idq₂+ . . . p₁I_{ldq}=−(p₁Idp₁+p₂Idp₂+ . . . pᵢIdp₁)

V=(m₁/M)Id(M/m₁)+(m₂/M)Id(M/m₂)+ . . . . +(m_{L}/M)Id(M/m_{L})=

$$\begin{matrix}V = - {\sum }_{i = 1}^{L} \frac{{m}_{i}}{M} * ld \frac{{m}_{i}}{M} \\ = - {\sum }_{i = 1}^{L} \frac{{m}_{i}}{M} * ld \frac{{m}_{i}}{M} \\ = - {\sum }_{i = 1}^{L} {p}_{i} * {ldp}_{i}\end{matrix} \qquad Formula 10$$

The value V determined according to the above formula is called mean economic info potential (short info potential) of an economic space. V contains characteristics, which follow from the dynamisation likewise like those, following from the static of an economic space R_{eco}. V is independent of scalings.

The formula for V is identical to the Shannon formula for the determination of the average information of a source. V can be regarded with terms of the information theory as average transfer characteristic of a channel.

The same formula (Boltzmann/Planck formula) is used in thermodynamics for the determination of the entropy. In thermodynamics it must be considered that in a real gas moved particles are undertaken into a continuous transformation in itself of their phase space (space from impulse and local coordinates). All possibilities of the transformation are given by a distribution formula (W=w₁I/(ΠwᵢI)), from which the above formula (over some steps of the simplification, e.g., Stirling formula) are derived.

The economic aspects introduced here reflect an alternative aspect to that of communication theory and to that of physics. From these short notes it is evident that in all three cases of the application of above formula the connection of static with dynamic aspects plays a role.

Since in economic application, like in the communication theory the binary logarithm Id is used (the number of 2 is powered), the economic info potential can be measured in the unit [bits]. The info potentials for the above example of the pairs of shoes result to:

$$\{ \begin{matrix}\begin{matrix}{“ Xin ”}_{1} \to 500 “ EURO ” \\ {“ Xin ”}_{2} \to 700 “ EURO ”\end{matrix} \\ {“ Xin ”}_{3} \to 300 “ EURO ”\end{matrix} , \begin{matrix}\begin{matrix}{“ V ”}_{1} \to 476.680 “ [ μ bit ] ” \\ {“ V ”}_{2} \to 633.515 “ [ μ bit ] ”\end{matrix} \\ {“ V ”}_{3} \to 294.426 “ [ μ bit ] ”\end{matrix} \} \qquad Formula 12$$

Since the economic info potential (if referred to the same economical space, i.e., the same amount M of money) is addable it is calculated to: 1395.624 [μ bits] for the total potential of the shoes in the shop window (with: 1μ bit=10⁻⁶ bits).

If only one pair of shoes is contained in the shop window, it is calculated to:

V=−m₁/m₁·Id(m₁/m₁)=−1·Id1=0 [bit] Formula 13

If the local money potentials are identical (m₁=m₂=m₃=100), it is given for info potential V:

V=−(3·(⅓)=Id(⅓))=Id3=1.58496 [bit] Formula 14

The 4 Fundamental Observables of the Humatics and their Determined Units

With observables are to be marked in humatics computable, measurable quantities. The number of humans B is such a quantity, as it is a money supply M, as it is also the number L of the space dimension. If the time as an economic period Z is added as last observable, the four fundamental observables are complete, from which many further observable can be derived by combination. Like that the income Y is a money flux, i.e. money amount per time M/Z. The unemployment rate is the relation of humans, which are searching for a job in relation to the persons employed B₁/Bₚ etc.

In the following are indicated some mathematical relations between the fundamental observables.

Observables and Their Relations

Mathematically it can be shown that with evenly distributed money potentials (mᵢ=constant) in a space L the info potential V takes its max. value and is to be calculated by: Vₘₐₓ=Id L. This can be inerpretated in such a way: If all money potentials are assembled in one point (mᵢ/M=1), the info potential takes its minimum value (V=Vₘᵢₙ₌0), the only possible information is given the info potential “0”. If all money potentials are identic (m₁=constant), the info potential gets its max. value (Vₘₐₓ=Id L), all possible information can still be unfold in the different values m₁ (they are still unused).

With above remarks a max. transfer rate of information value is to be written for each economic info potential of a subspace with the dimension number L=Λ:

Φ=VₘₐₓIdΛ

V=xΦ=xIdΛwith: 0≦x≦1

x=V/Φ=V/(IdΛ) with x: evenness

μ=1−x with μ : specifity Formula 15

With Formula 1 5 a specific measure, the “equal measure” of x is assigned to each economic subspace of the dimension A. Since x can only take numbers in the interval 0≦x≦1 it is suitable to compare spaces of different size. This characteristic is caused by the fact that to each subspace Λa max. information potential is given by the dimension number Λ: Vₘₐₓ=Φ=Id Λ. The larger the value of x, that means the more the value of 1 is reached, the more evenly occupied with values m, is the regarded space. As specificity of a subspace the value μ=1−x can be called.

In the following the economic information potentials V_{L1}, V_{L} of subspaces with the dimension numbers of Λ₁, Λ₂ are added:

$$1 \text{:} {V}_{Λ1} = - {\sum }_{i = 1}^{Λ1} \frac{{m}_{Λ1 , i}}{{M}_{Λ1}} ld \frac{{m}_{Λ1 , i}}{{M}_{Λ1}} ; {V}_{Λ2} = - {\sum }_{j = 1}^{Λ2} \frac{{m}_{Λ2 , j}}{{M}_{Λ2}} ld \frac{{m}_{Λ2 , j}}{{M}_{Λ2}} ; \\ 2 \text{:} {V}_{Λ1} = - {\sum }_{i = 1}^{Λ1} \frac{{m}_{Λ1 , i}}{M} ld \frac{{m}_{Λ1 , i}}{M} - {\sum }_{j = 1}^{Λ2} \frac{{m}_{Λ2 , j}}{M} ld \frac{{m}_{Λ2 , j}}{M} = x ld L \\ with M = {M}_{1} + {M}_{2} ; L = {L}_{1} + {L}_{2} \qquad Formula 16$$

From the above relations it is to be taken that the info potential of a space, which consists of subspaces, is to be determined only with knowledge of all values m_{Λ1,1}, m_{Λ2,j}. The simple addition of V_{Λ1}+V_{Λ2} leads to a false result, since the mᵢ are not referred to a joint value. This can be interpreted also in such a way: If the values of economic subspaces are intended for the use of channel transfer, it cannot be judged from the total of these values onto a channel channel, which is necessary for the transfer of all individual values. For many cases can the following approximation for the addition of info potentials be used, if it is done without the knowledge of the individual values m_{Λ1,1}, m_{Λ2,j}:

1:V=x_{Λ1}IdΛ₁+X_{Λ2}IdΛ₂=xId(Λ₁+Λ₂)

2: \overline{x}=x₁+x₂=V₁/(2 Id Λ₁)+V₂/(2IdΛ₂)

3: \tilde{V}=\overline{x}Id(Λ₁+Λ₂) Formula 17

In the first line of the above formula the information potential V of a space is indicated, which consists of the subspaces with the dimension numbers Λ₁, Λ₂. This formula corresponds with line 2 of the Formula 16. With the average measure of x (Formula 17 line 2) an approximative value for the info potential of the space with the dimension number of Λ₁+Λ₂ can be calculated in line 3. The formulas indicated for two subspaces can be extended accordingly to subspace of n dimension.

The Economic Temperature

Apart from the evenness can be derived a further specific quantity T for economic spaces, if the quantity of the volume of money M available in a space is set in relation to the economic info potenial V:

1: T=M/V=M(x IdΛ) [symbol] xT=M/(Id A)=constant for space A

2: T₀=M/(IdΛ) with x=1

3: \overline{x}T=T₀ Formula 18

With x=1, i.e. V=Vmax a minimum temperature T₀ results if all the m, are constantly distributed in the complete space.

In the case of combining two spaces the following formulas for the economic temperature results:

1: T M/V=(M₁+M₂)/(xΦ)=(M₁+M₂)/(x ld(Λ₁+Λ₂))=T₀/x; T₀(M₁+M₂)/ld(Λ₁+Λ₂)

2:x₁=T₀₁/T₁=M₁/(T₁Φ₁); x₂=T₀₂/T₂=M₂/(T₂Φ₂)

3: \overline{x}=(x₁+x₂)/2

4: \overline{x}\tilde{Γ}=T₀=(M₁+M₂)/ld(Λ₁+Λ₂)

5: \tilde{T}T₀/\overline{x}=1/\overline{x}·(M₁+M₂)/ld(Λ₁+Λ₂)=M/\tilde{V}

6: M=\tilde{T}\tilde{V} Formula 19

Out of the above derivations in Formula 18, 19 it is to be taken that there are two types of analyze of information potentials V and temperatures T in economic spaces (subspaces). If all distributions of the mᵢ in the individual subspaces are present, the V and I of the total space can be determined accurately. If only the summary M-values and the L-values are known, approximative values \tilde{V}, \tilde{T} can be determined.

The Human Potential

That above introduced economic space for products and performances R_{eco} is an abstraction of the result of human, economic activities, i.e. the economic space is only generated (constituted) by human abilities and knowledge. In the following are connections between the economic space R_{eco} and the space of the human abilities and knowledge R_{hb} are to be pointed out, whereby it is assumed that all values in the subspaces are known. For this purpose a scale is introduced, which represents a reference base for human abilities and knowledge. In the case of use of this scale the economic potentials can be added.

In market economies humans with their skills and abilities have a special meaning. The skills and abilities decide on the competition power of products, enterprises and market economies. The abilities and skills, which in market economy are required, are well-known. There are first of all those, with which economic goods are produced, which exist in the competition with other goods at the market (which are to be sold, compete, “survive”). These required abilities and skills can be determined in doubt by asking economically active humans, enterprises. There are secondly in addition, the cultural abilities and skills, which decide on the competitive power of a free-market economy (of enterprises, of humans). Since the economic future is open i.e. unknown, cultural performances of humans (e.g. from the care of health up to artistic or sportive activities) can turn out to be the main sources for powerfull competition. For this reason must be counted as abilities and skills which generate the success of a free-market economy, also the cultural spectrum of skills and abilities of a society. So the health of humans is not an actual but probably however a potential source of competition. The inventive capacitiy, like the research performance of humans can be promoted by the entire cultural surroundings etc.

The abilities and skills needed for the solution of tasks are named in the following as the applicative human potential of an economy, the not directly needed skills and abilities are named as internal human potential.

The entire, countable abilities and knowledge can be written into a list of the length L, whereby each list position (Idntf i: Identifier) indicates a certain skill or ability. This list in named potential scale (here in particular: Pₓ-Scale) and can be understood as the generic code of an economy (a society). Thus by the Pₓ-Scale a subspace of the economic space is spanned, which is given by the L in the Pₓ-Scale listed skills and abilities.

Mathematically the Ps-Scale can be understood as an unit vector, which contains a “1” at the positions of the identifier.

\vec{P}ₓ:{1_{Idntf1}1_{Idntf2}, . . . . 1_{IdntfL}} Formula 20

Skills and abilities have exactly the monetary value, which free market oriented society is ready to pay according to their proof (their presence). Humans can prove by test, examination, competition etc. which skills or abilities are avaible to them. Each list position Idntfᵢ of the P-Scale can be assigned by that money value mi, which a society is ready to pay per year for humans as bearer of skills, abilities, if the skills, abilities are examined in a test, examination, competition (is provable). Since money values can be interpreted also as potentials, which by their value determine, which economic activities (money flux, good production, service offers, added value chain etc.) are activated, the money values m, in the generic P-Scale represent their own economic expression potential. For a Pₓ-Scale occupied with values can be written:

\vec{P}ₘ: {m_{idntfl1},m_{idntfl}2, . . . m_{IdntflL}} Formula 21

In the following for this Pₘ-Scale mostly a simplified mathematical writing is used:

\vec{P}ₘ={m₁,m₂, . . . m_{L}} Formula 22

This Pₘ-Scale is shortly named P-Scale and is mostly referred to in this interpretive section.

The L identifier of a P-Scale can be understood as position indicators in a memory of an electronic computing system. Since L for a society can quite be in the range of L>10000, an appropriate number of marked memory places is to be designated, which are occupied with the values m₁.

In the following example a shortened P-Scale of the length L=4 is shown in tabular form and in a diagram represented (FIG. 5). The special form of this diagram is called economic distribution. In an economic distribution therefore the different (not combinable, incommensurable) coordinates X of the economic space are represented in the X-axis and the related values are represented in the Y-axis.

The economic distribution of the FIG. 5 refers to the R_{eco}, i.e. to incommensurable (not combinable, not directly comparable economic goods) human abilities and skills. In accordance with the above remarks the L identifier determine a point in the economic space, whose coordinates are determined by the L identifier (performances and knowledge). The space Rₚ described by the P-Scale is a sub space of the economic space R_{eco} described above.

Also to this by the different skills and abilities spanned space can be assignet an uniform measure (in the unit [bits]) which is by use of the method mentioned above independent of scaling. If the economic potential of the P-Scale is determined, it can be interpreted as human info potential of the economic space. Because of its outstanding meaning it receives the designation human potential H. Thereby the human potential is a value, which results from the evaluated abilities of humans. For the individual space points the Shanno formula reads:

$${h}_{i} = - ( {m}_{i} / Msum ) \cdot ld ( {m}_{i} / Msum ) \to H = {\sum }_{i = 1}^{L} {h}_{i} \qquad Formula 26$$

The potential vector of the human potential is given to:

\vec{P}ₕ={h₁,h₂, . . . h_{L}} Formula 27

As example are given in the follwing table the human potentials of the Pₘ-Distribution of FIG. 5 to which are the Pₕ-Distribution is given FIG. 6:

$${“ h ”}_{1} \to 0.5243 “ [ bit ] ”$$

$${“ h ”}_{2} \to 0.5217 “ [ bit ] ”$$

$${“ h ”}_{3} \to 0.4528 “ [ bit ] ”$$

$${“ h ”}_{4} \to 0.25 “ [ bit ] ”$$

The total human potential H to FIG. 6 is given to:

1.45915 [bit] Formula 32

The Individual Human Potential

From the large quantity of skills and abilities which are contained in a P-Scale of the {Idntf₁, Idntf₂, . . . . Idntf_{L}} individual persons hb will have proven or have proven a certain subset of Q_{hb}={Idntfₘ, Idntfₚ, . . . Idntfᵣ} in tests, examination or competitions. Q_{hb} is therefore one point of individual persons in the L-dimensional space, which is spanned by the P-Scale. In the following the letter Qₕ (human potentials) for persons represented as two-dimensional, economic distributions.

In the FIG. 8 bit units of 10⁻⁶ bits=1 μbit (“1 micro bit”) were selected. The length of the distribution of humans is indicated as L_{hb} (=amount of abilities and skills). The dimension of the Y-axis in the FIG. 7 differs from that in the FIG. 5, since an individual Q-Distribution deals with the representation of paid money, which are paid for the proof fo skills and abilities. As measuring unit the money value per economic period [EURO/Year] is indicated. Because of the independence of scalings (also dimension scalings) the hᵢ-values of the PₕScale (the Pₕ-Vector) can be taken unchanged. The individual values (money fluxes) of a Q_{hb}-distributions receive the symbol ω.

At a first sight the distribution money values of an economic space (FIG. 7) seems to be proportional to those of the human potential (FIG. 8). Relations of neighboured h-values or m-values show that this is not the case. Which is at least due to the above derivation of the formula for the calculation of the economic human potential and which is expressed by the following in equation:

$$\begin{matrix}\frac{{m}_{i}}{{m}_{i + 1}} \neq \frac{{h}_{i}}{{h}_{i + 1}} = \frac{( {m}_{i} / M ) ld ( {m}_{i} / M )}{( {m}_{i + 1} / M ) ld ( {m}_{i + 1} / M )} \\ = \frac{{m}_{i}}{{m}_{i + 1}} \frac{ld {m}_{i} - ld M}{ld {m}_{i + 1} - ld M}\end{matrix} \qquad Formula 35$$

With Formula 26 for the derivation of the measurement of the individual values of the human potential h₁ also performances of the human brain can be determined. Abilities and skills are assigned to the different physical/biological space points (brain) and there are differently evaluated (occupied with human potentials h₁). The biological aspect of a sequentially transformed space into itself (brain activity) is to be determined by the characteristic of the Shannon j formula. A knowledge of the actual, biological structure of the brain is not necessary on this abstraction level. Any data processing system can be characterized by the mentioned measuring method (the described mathematical method).

It will turn out in the following that with the separation of the human potential in one part which is needed for the solution of external tasks and into an other part which is internally available for the solution of task new insights into the concept of information appear. First some relations of the human potential are given.

The 4 Fundamental Observables of Humatics and Their Derived Units.

With observables are to be called in humatics countable, measurable units. The number of humans B is such a unit, like it is a money amount M, as it is alos the amount of skills and abilities L. If the time as the last observable is added in form of an economic period Z, the four fundamental observables are assembled, from which the many further observablen can be derived by combination. Therefore the income Y is a money flux, i.e. money amount per time M/Z. The unemployment rate is the relation of persons, which are looking for a job in relation to the persons employed B₁/Bₚ, the human potential consists of money amounts (or quantities of money flux) and the number of skills and abilities and gets a new unit [bits] etc.

In the following some mathematical relations between the fundamental observables are shown.

Are the m₁=constant distributed over the Pₘ-Scale evenly, the maximum value of the Pₘ-Scale is given by the value H_{PScl}=IdL. Each value H_{PScl} of unequally distributed m₁-values of the Pₘ-Scale are therefore smaller than Hpscl with which can be written:

H_{Pmax}=ˆ H_{PScl}=IdL→H_{PScl}=x_{PScl}IdL;

with: 0≦x_{Pscl}≦1

\overline{h}_{Pscl}=H_{PScl}/L=IdL/L→x_{PScl}=\overline{h}·_{PScl}·L/(IdL) Formula 36

If in the values of the Pₘ-Scale information is contained about the values of the knowledge and abilities which are available in a society, the values x_{Pscl}, h_{Pscl} can be used for the comparison with that data, which are result from the data of the employees in companies. For the human potential of an employee hb are resulting the the following relations under use of the Formula 36:

\overline{h}_{hb}=H_{hb}/L_{hb→x}_{hb}=\overline{h}_{hb}·L/(IdL)

ζ=x_{hb}/x_{PScl}=\overline{h}_{hb}/\overline{h}_{Pscl} Formula 37

In the first line of the Formula 37 the average human potential per employee \overline{h}_{hb} is determined. In the right part of the formula this value h hb is multiplied by the same value L/IdL, which arises only from the L-value of the P-Scale. Thus we receive ζ in the second line by the relation \overline{h}_{hb}/\overline{h}_{PScl}. For ζ>the individual hb has a larger, average human potential than it is given by the values of the Ph-Scale.

The relation from money flux (e.g., turn over, income . . . , expenses) to human potential is defined as economic temperature T. For companies the relation of social profit D=Y−Ω to the total of the human potential H of the employees is defined as temperature:

T=D/H=(U−Ω)/Σh_{hb} Formula 38

The value Ω results from the total ω₁ of the individual employees. Since Ω can be understood as the value a society is ready to pay for the proven skills and abilities of their employees, the social profit (D=U−Ω) can be interpreted as the surplus which a company gains at the market additional to 0.

If the values D, H, T of sequential economic periods are compared there arise a set of new economic units such as success, stability, effectiveness, which are presented in the following:

δ=D₂/D₁=(T₂/T₁)/(H₂/H₁)=ντ=(T₂/H₁)/(H₂/T₁)=ES Formula 39

with: ecomonic success δ, H-Amplification ν, T-Amplification τ economic effectivity E, economic stability S;

The value δ (delta) is called economic success and can be represented in different ways. As definition is given the relation of D₂/D₁ which can be represted by the different quotient combinations of T, H. The relation T₂/T, is called T-Amplification τ (tau). With τ>1 increases the economic temperature, with τ<1 it decreases. An appropriate value is to be formed from the relation H₁/H₂, which is called stability ν (nü). With ν>1 the economic potential increases between two periods, with ν<1 it decreases.

The relation H₂/T₁ is called stability quotient S. If the human potential of a subsequent period H₂ increases in relation to the temperature T1 of the preliminary period, there is more human potential for the solve of tasks available than it has been during the preliminary period. Appropriate relations apply to the effectiveness. Increases the temperature T₂ of the new period in relation to the human potential H₁ of the preliminary period, more social profit is gained out of the abilities and skills of employees.

As further economically (and macro economically) usable units arise the economic resistance ρ (rho), the economic moment φ (phi) and the economic comfort F:

1: ρ=ν/τ [symbol] δ=ντ=ρτ²=ν²/ρ

2: φ=HΦ=DΦ/T [symbol] D=Tφ/Φ

3: F=dD/dφ=T/Φ [symbol] T=FΦ [symbol] φF=(DL/T)/(T/Φ)=D

4: D=TH=φF Formula 40

How much human potential amplification v is necessary for an increase of temperature amplification T, determines the amount of the economic resistance ρ (line 1 Formula 40). If a large human potential amplification is needed, for getting an arise of temperature amplification, the economic resistance ρ is large and vice versa. As can be seen from line 1 of the above formula, the economic resistance ρ is the only unit, which is contradictionary to the increasing of economic success δ which arises from the increase of the human potential (ν>1).

The economic moment φ (line 2, Formula 40) can be interpreted as the surface, which is spanned by a human potential and the number of the skills and abilities in the subspace defined by Φ. If the surface (the product HΦ) is large, humans, companies have a large economic moment φ.

Line 3 of Formula 40 determines the derivation of the social profit with respect to the economic moment dD/dφ, the result T/L indicates the ratio of T to the amount of abilities and skills Φ and is named economic comfort F. The economic comfort can be interpreted in such a way: If a high temperature T is achieved at small number of knowledge and abilities Φ, the comfort is large. From few skills and abilities is obtained a large social profit per human potential.

With line 4, Formula 40 is found a further expression of the social profit D. In all formulas, in which D occurs, it can be used instead of the product T H the economic moment φ times economic comfort F. This is executed in the following formulas.

1:δ=(φ₂/φ₁)(F₂/F₁)=φf=ντ; with: φ=φ₂/φ₁

2: δ=D₂/D₁=(T₂φ₂/Φ₂) (Φ₁/(T₁φ1))=τφ/λ with: λ=Φ₂/Φ₁

3: δ=D₂/D₁=(T₂H₂)/(T₁H₁)=(F₂Φ₂)/(F₁Φ₁)ν=fλν

4: Υ=τφ/λ=τφfν/δ [symbol] δ²=τφfν [symbol] δ=(τφfν)^{0.5}

5: δ²=φfν²/ρ [symbol] δ=ν(φf/ρ)^{0.5} Formula 41

The relations of the Formula 41 are given from line 1 by elementar rules out of the methods of humatics.

The Individual Human Potential in Macor Economic Application

Among political economists it is widely accepted that the rise of the average income of humans in a national economy can be seen as a measure for the characterisation of prosperity. From this characterisation of prosperity new insights into economic relations result by combination with the units of humatics.

$$1 \text{:} ξ = \overline{- {Y}_{2}} / \overline{{Y}_{1}} = ( {Y}_{2} / {B}_{p2} ) / ( {Y}_{1} / {B}_{p1} ) = {qY}_{2} / {Y}_{1} ; \\ \text{with:} q = {B}_{p1} / {B}_{p2} und p = 1 / q = {B}_{p2} / {B}_{p1} \\ 2 \text{:} \begin{matrix}ξ = \overline{{Y}_{2}} / \overline{{Y}_{1}} = {qY}_{2} / {Y}_{1} \\ = q ( {D}_{2} / ( 1 - {r}_{2} ) ) / ( {D}_{1} ( 1 - {r}_{1} ) ) \\ = q ( 1 - {r}_{1} ) / ( 1 - {r}_{2} ) {D}_{2} / {D}_{1} \\ = q ( 1 - {r}_{1} ) / ( 1 - {r}_{2} ) δ = q ( 1 - {r}_{1} ) / ( 1 - {r}_{2} ) S E\end{matrix} \\ 3 \text{:} S = {H}_{2} / {T}_{1} ; E = {T}_{2} / {H}_{1} ; \\ 4 \text{:} δ = S E = ( {H}_{2} / {T}_{1} ) ( {T}_{2} / {H}_{1} ) = {D}_{2} / {D}_{1} \\ 4 \text{:} ξ = q ( ( 1 - {r}_{1} ) / ( 1 - {r}_{2} ) ) S E \\ 5 \text{:} ξ = {qr}_{f} S E = {qr}_{f} δ \text{with:} {r}_{f} ( 1 - {r}_{1} ) / ( 1 - {r}_{2} ) \qquad Formula 43$$

In the line 1 of Formula 43 is given the relation of the average income between two periods as \overline{Y₂}/\overline{Y}₁. This quotient is named here ξ (xeta) as prosperity characteristic. If for \overline{Y} the definitions \overline{Y}/Bₚ are used, whereby with Bₚ are given the amount of persons in production and Y is to represent the national income, then it results between the quotient q and ξ the relation of the first line.

The quotient q=Bₚ₁/Bₚ₂ (with Bₚ₁ number of employed persons in the economic period 1, Bₚ₂ number of employed persons in the economic period 1) can be used for the characteristic of the released employees. If q is large, more employees in the preliminary period have been employed in relation to the subsequent period, therefore employed persons have benn set free, therefore the quotient q is called release quotient. The reciprocal value p=1/q=Bₚ₂/Bₚ₁ can be used for the characterisation of the demand for employees. If this value is large, more workers in the subsequent period in relation to the preliminary period were used. If the number of persons employed is larger in one preliminary period Bₚ₁ than in one subsequent period Bₚ₂, are fewer employees have a job, which in the long run will lead to unemployment in today's market economies if the total of the population remains constant. In this sense p (or q) indicates the development of the unemployment ratio, therefore this relation is used in the economic analyses of humatics. The quotient p is called employment quotient.

In the second line of the Formula 43 the value Y is replaced by values which are given by the methods of humatics. From Ω=rY and D=Y−Ω results Y=D/1−r, which finally leads by use of the known methods of humatics to the right expression in line 2 of Formula 43. The factor r_{f} in line 5 shows the influence of the modification of the values r₂, r₁. If r₂ rises the value in the denominator of r_{f} is reduced i.e. r_{f} grows. Ω can be understood as the part of the income Y, which has to be paid on educational purposes. The different ways of writing of the last expressions of the Formula 43 are:

1: ξ=qr_{f}δ [symbol] q=ξ/(r_{f}δ) [symbol] δ=pξ/r_{f}

2:, ξp=r_{fδFormula} 44

From the above three expressions are to be derived the contents of the usual discussions between employees and entrepreneurs in market economies.

The left expression of the Formula 44 states: The prosperity increases with rising release ratio (decreasing amount of persons employed: Bₚ₁>Bₚ₂→q>1), rising economic success (D₂>D₁→δ>1) and with increasing part of the expenses for education (r_{f}>1). If less people are employed at increasing economic success, that is a strong indication of rising prosperity. In this sense is the decrease of employment rates only and expression of the release of labour.

From the middle formula it can be clearly seen, that with constant income rise (e.g. ξ rises annually around 2% to 3%, in usual market economies) unemployment can be promoted, if the economic success ξ, i.e. the competition result of the companies are not larger than the income rise. This might be the principle discussion base of entrepreneurs side.

The right expression in the Formula 44 is mostly used by the employee's side: Economic success increases with the product of unemployment quotient q (Bₚ₂>Bₚ₁→p>1) and prosperity indicator ξ and decreases with the grows of the expenses for education performances.

If for a free-market economy it is assumed a constant of the product r_{f}δ, e.g. stagnation, r_{f}δ=1 it is also the product of ξ p constant, i.e. rising prosperity is given only with decreasing demand for labour.

The results of the above analyses (Formula 43, Formula 44) were already well-known before the elaboration of humatics, if for δ only the relation of the incomes Y₂/Y₁ is used. See first line of the Formlula 43. Also by the additional use of the value of the expenses for education performance Ω results no basically new insights, which could not have been won with the methods of the conventional economics. Even if in the relevant text books of the economics these relations are not to be found, they are nevertheless implicitly contained in the formalisms of micro and macro economics.

Simplifying said, the above formulas determine the prosperity proportionally to the income. This follows from the definition of the prosperity in line 1 of Formula 43. If are used for economic success 6 the different expressions of the humatics, the multiple new relations between prosperity and the values of the humatics are discovered:

ξ=qr_{f}δ=qr_{f}(H₂/H₁)(T₂/T₁)qr_{f}ντ=qr_{f}SE=qr_{f}ρτ²=qrfν²/ρξ=qr_{f}φf=qr_{f}τφ/ λ=qr_{f}λν=ν(φf/ρ)^{0.5} Formula 46

In the different expressions the product q r_{f} remained unchanged. It is an empirical quantitiy which determines, how the amount of humans in production depends on the expenses for education performances. It can be easily seen that with the increase of r_{f} (r2>r1), i.e. increase of the education income Q as part of the total income Y, the prosperity decreases. That is the result, if prosperity is closely connected to the average individual income by the prosperity indicator ξ=\overline{Y}₂/\overline{Y}₁. In addition, with the increase r_{f} the incentive for changing from production to education is increased so that the number of the unemployed persons will decrease.

The Quadratic Growth of the Prosperity

If for a national economy the total of the individuals in the education and the individuals in production is set constant (first line of the Formula 47), the line 3 of the formula 47 results. Increases B_{E2} becomes the difference B_{C}−B_{E2} in the denominator smaller, which leads to an increase of the value of the ratio, i.e. the prosperity increases with increasing amount of humans in education.

1: B_{C}=Bₚ+B_{E}=constant

2: Bₚ=B_{C}−B_{E}

3ξ:=qfᵣSE=(B_{C}−B_{E1})/(B_{C}−B_{E2})fᵣSE Formula 47

In the following is to be demonstrated, how the prosperity of a national economy is to be determined, if the human potential of the humans in the education sector echanges continuously with that of the humans in the production sector, i.e. if skills and abilities within both econmic branches adapt and adjust to each other. For this case it is to be set that the average human potential of humans is in the production sector (commercial sector) equal to that of humans, who are in education, it can thus be set: \overline{h}ₚ=\overline{h}_{E}. This situation is achieved exactly if humans between production and education echange contnously, i.e. a close informal exchange between these two sectors exists.

1: ξ=qfᵣδ=qfᵣH₂/H₁=qfᵣτ(Bₚ₂\overline{h}ₚ₂+B_{E2}\overline{h}_{E2})/(B_{P1}\overline{h}_{P1}+B_{E1}\overline{h}_{E1})

2: ξ=qfᵣτ(\overline{h}₂(Bₚ₂+B_{E2}))/(\overline{h}₁(B_{P1}+B_{E1}))

with: \overline{h}₁=\overline{hₚ₁}=\overline{h_{E1}}; \overline{h₂}=\overline{hₚ₂}=\overline{h_{E2}}

3: ξ==qfᵣτ\overline{h₂}/\overline{h₁} with: Bₚ+B_{E} constant

4: ξ=qfᵣτ(Hₚ₂/Bₚ₂)/(Hₚ₁/Bₚ₁)=qfᵣτ(Hₚ₂/Hₚ₁)(Bₚ₁/Bₚ₂)=qfᵣτνₚ

5: ξ=q²fᵣτνₚ Formula 48

In the first line of the Formula 48 the total-human potential in a national economy is determined from the human potential of humans in production (Bp) and that of humans in the education (B_{E}). With ideal exchange of knowledge (skills and abilities) between the production and the education sector the simplification between line 2 and 3 can be introduced. In line 4 e.g., \overline{hₚ}=Hₚ/Bₚ (also \overline{h}_{E}=H_{E}/B_{E} is possible under the made assumptions) can be set, whereby the quadratic dependency between prosperity and release (unemployment) ratio results.

The result derived in Formula 48 throws a perfectly new light on market economies: If an intensive exchange of humans (their knowledge) between education and production takes place, the prosperity grows quadratic with the number of humans, who are set free from production (and change into the education sector).

How does this result with its extensive, social effects appear? If we compare line 1 in Formula 48 with line 3, we see in the two following expressions

ξ_{λ}=qfᵣτH₂/H₁ [symbol] ξ_{B}=q fᵣτ\overline{h}₂/\overline{h}Formula 49

that the quotient H₂/H₁ has changed into the quotient \overline{h}₂/\overline{h}₁. The value of a first quotient H₂/H₁ which is not on average is transformed into an averaged value \overline{h}₂/\overline{h}₁. For the increase of an average value is a substantially larger performance necessay, since for the increase of an average value of 1% also on the average all individual values must rise accordingly.

That result, transferred to national economies means, by continuous exchange of skills and abilities between production and education the average value of the human potential (average value of the quantity of the knowledge, average value of the quantity of skills and abilities) is increased. This leads to a quadratic increase of the release (unemployment) ratio.

In the long run the above result means: The today's market economies, in which a continuous knowledge exchange between production and education is missed, produce a prosperity, which is proportional to the release ratio q of the persons employed. As in existing market economies the tendency for an increase of the human potential is to be observed, the release ratio (i.e. vice versa in the today's market economies the unemployment ratio) will continue to increase. Thus the prosperity will continue to grow (with increasing release of labor-willing persons, i.e. with the danger of increasing unemployment). The way out is to offer to the set free humans to pay to them for their education activities as alternative for the unemployment benefit. Therefore the release from procutive labour is compensated by promotion the education efforts, the prosperity can grow quadratically. Thus in the future a free-market economy is possible, which generates a maximum of knowledge with a minimum of labor. The presence of humans in production replaced by an increased presence of human potential (“bit presence level”).

Cooperative Human Potential

In operations humans combine their abilities and skills in such a manner that the products and services offered by their operation compete as successfully as possible against the products and services of other companies. From the formulas of humatics values and reference indicators can be derived, which complete the well-known operational methods of controlling and analyse. Concerning the evaluation of the human potential the well-known methods of controlling become their full completeness by the results of the humatics.

For the solution of tasks humans can cooperate together, by combining their abilities and skills. Humans, who cooperate for the solution of a task, will have different abilities and skills from which in the rule only some for the solution of the task are necessary. For a task can also be repeated abilities necessary, if e.g., an ability at a place (e.g. engine A, storage hall X etc.) and for the same time at a different one is need. For companies or national economies it might be important to know the surplus or the requirement of the human potential which is needed for tasks.

All these problems can be solved with the help of humatics.

With \vec{A} an application vector is introduced, which consists of the same elements like a p-scale consists of. In this vector the two request for a task are contained—naming and multiplicity (frequency) of the necessary abilities—for a solution.

\vec{A}={1, 0, . . . αᵣ, αₛ . . . , . . . , 1 , . . . } Formula 50

In the application vector [symbol] A “1” presents as necessary, “0” a not necessary and αi for the frequency of an ability or skill. Since abilities, skills are represented only by humans and each human can present an ability or skill only once, e.g., a factor α=2 in indicates a skill or ability is two time needed, that means two humans are needed. αi can also be a real number (e.g., 5/3, √2). From the application vector A two vectors can be derived:

[symbol]

A_{E}={1, 0, . . . 1, 1 . . . 0, . . . 1, . . . }

[symbol]

A_{E′}={0, 1, . . . 0, 0 . . . 1, . . . 0, . . . } Formula 51

The e,rar A_{E} contains a “1” for necessary abilities and skills and otherwise a “0”. In the places of the [symbol] A_{E′} the numbers of “1” are exchanged to “0”. [symbol] A_{E} is called unit vector of the application vector [symbol] A, [symbol] A_{E′}, is the inverted [symbol] A_{E}. Both vectors are needed in the following.

If the application vector A is applied on [symbol] Aₕ, the necessary application vector [symbol] Aₕ presents the needed human potential for a task (application):

[symbol]

Aₕ= [symbol] Aₕ={h₁, 0 . . . . . . αᵣ, hᵣ, αₛ hₛ . . . 0, . . . hᵤ.} Formula 52

As example the following original data are to serve (1. column: Pₘ-Scale; 2. column: Pₕ,-Scale; 3. column: Factors αi for application vector; 4. column: Identifier and needed human potential for the task):

$$\begin{matrix}Idntf 1 \to 100 EURO & 139.435 mbit & α1 \to 1 & Idntf 1 \to 139.435 \\ Idntf 2 \to 200 EURO & 225.537 mbit & α2 \to 0 & Idntf 2 \to 0. \\ Idntf 3 \to 50 EURO & 83.0509 mbit & α3 \to 2 & Idntf 3 \to 166.102 \\ Idntf 4 \to 400 EURO & 344.407 mbit & α4 \to 2 & Idntf 4 \to 688.815 \\ Idntf 5 \to 800 EURO & 475.481 mbit & α5 \to 0 & Idntf 5 \to 0. \\ Idntf 6 \to 100 EURO & 139.435 mbit & α6 \to 1 & Idntf 6 \to 139.435 \\ Idntf 7 \to 700 EURO & 452.007 mbit & α7 \to 1 & Idntf 7 \to 452.007 \\ Idntf 8 \to 300 EURO & 291.508 mbit & α8 \to 0 & Idntf 8 \to 0. \\ Idntf 9 \to 500 EURO & 387.585 mbit & α9 \to 1.1 & Idntf 9 \to 426.344 \\ Idntf 10 \to 600 EURO & 423.017 mbit & α10 \to 1 & Idntf 10 \to 423.017\end{matrix} \qquad Formula 54$$

With the unit vector [symbol] _{E} the total of the human potential needed for the task can be determined from the application vector [symbol] ₕ:

H_{need}= [symbol] ₕ· [symbol] _{E}=α₁h₁ + . . . αᵣhᵣ+αₛhₛ+ . . . αᵤhᵤ Formula 55

For the above data the total of the values of the column 4 gives:

H_{need}:→2435.15 bit Formula 57

The resulting vector from the co-operation of humans results to:

$${\vec{Q}}_{cop} = {\vec{Q}}_{h1} + {\vec{Q}}_{h2} + {\vec{Q}}_{h3} + … {\vec{Q}}_{hn} = {\sum }_{i = 1}^{n} {\vec{Q}}_{hi} \qquad Formula 58$$

For the above example the Qₕ-vectors of the columns 1, 2, 3 which are to serve the resulting vector Q_{cop} are given in the column 4:

$$\begin{matrix}{h}_{1} \to 139.435 & {h}_{1.} \to 139.435 & {h}_{1} \to 0. & {h}_{1} \to 278.87 \\ {h}_{2.} \to 0. & {h}_{2} \to 225.537 & {h}_{2.} \to 0. & {h}_{2.} \to 235.537 \\ {h}_{3.} \to 83.0509 & {h}_{3} \to 83.0509 & {h}_{3.} \to 83.0509 & {h}_{3.} \to 249.153 \\ {h}_{4} \to 0. & {h}_{4} \to 344.407 & {h}_{4.} \to 344.407 & {h}_{4} \to 688.815 \\ {h}_{5.} \to 475.481 & {h}_{5.} \to 0. & {h}_{5} \to 0. & {h}_{1} \to 475.481 \\ {h}_{6} \to 0. & {h}_{6.} \to 139.435 & {h}_{6} \to 139.435 & {h}_{6.} \to 278.87 \\ {h}_{7.} \to 0. & {h}_{7.} \to 0. & {h}_{7.} \to 0. & {h}_{7.} \to 0. \\ {h}_{8.} \to 291.508 & {h}_{8.} \to 0. & {h}_{8} \to 0. & {h}_{8} \to 291.508 \\ {h}_{9.} \to 0. & {h}_{9.} \to 0. & {h}_{9} \to 387.585 & {h}_{9.} \to 387.585 \\ {h}_{10.} \to 0. & {h}_{10.} \to 423.017 & {h}_{10.} \to 0. & {h}_{1.} \to 423.017\end{matrix} \qquad Formula 60$$

With the following formula the difference vector [symbol] ₕ can be determined, in which the surplus or the lack of human potential is indicated to the human which is cooperatively available:

[symbol]

ₕ= [symbol] _{cop}− [symbol] Aₕ Formula 61

For the above application vector with the indiviudal Q-vectors Δh is given to:

$$\begin{matrix}{h}_{1} \to 139.435 \\ {h}_{2} \to 225.537 \\ {h}_{3} \to 83.0509 \\ {h}_{4.} \to 0. \\ {h}_{5} \to 475.481 \\ {h}_{6.} \to 139.435 \\ {h}_{7} \to - 452.007 \\ {h}_{8} \to 291.508 \\ {h}_{9} \to - 38.7585 \\ {h}_{10} \to 0.\end{matrix} \qquad Formula 63$$

For the abilities, skills a₁, a₂, a₃, a₅, a₆, a₈ results a surplus of the human potential for a₇, a₉ occurs a lack, a₄, a₁₀ is sufficiently available in each case.

The Complex Economic Potential

With the introduction of the cooperative economic potential surplus and lack of human potential occurred for the solution of tasks. The partitioning of the human potential for task into necessary and not necessary parts is a general characteristic of the human potential and applies alos to indivicuals since a person will not need all abilities and knowledge for solving a task. The amount of the not needed part of the human potential will determine however the solution potential for the not foreseeable problems. Thus for the first time a possibility arises of making not foreseeable problems accessible to mathematical analyse. Of advantage is in this case the use of complex numbers.

If a person hb has L_{hb} abilities, skills, 2^{L}_{^{hb}} different combinations of compositions of these skills and abilities are possible. If a necessary knowledge and ability is marked with “1” and an unnecessary with “i”, the following combination options are given for the examples of the FIGS. 7, 8:

$${P}_{hb1} \to \{ i , i , i , i \} \\ {P}_{hb2} \to \{ i , i , i , 1 \} \\ {P}_{hb3} \to \{ i , i , 1 , i \} \\ {P}_{hb4} \to \{ i , i , 1 , 1 \} \\ {P}_{hb5} \to \{ i , 1 , i , i \} \\ {P}_{hb6} \to \{ i , 1 , i , 1 \} \\ {P}_{hb7} \to \{ i , 1 , 1 , i \} \\ {P}_{hb8} \to \{ i , 1 , 1 , 1 \} \\ {P}_{hb9} \to \{ 1 , i , i , i \} \\ {P}_{hb10} \to \{ 1 , i , i , 1 \} \\ {P}_{hb11} \to \{ 1 , i , 1 , i \} \\ {P}_{hb12} \to \{ 1 , i , 1 , 1 \} \\ {P}_{hb13} \to \{ 1 , 1 , i , i \} \\ {P}_{hb14} \to \{ 1 , 1 , i , 1 \} \\ {P}_{hb15} \to \{ 1 , 1 , 1 , i \} \\ {P}_{hb16} \to \{ 1 , 1 , 1 , 1 \} \qquad Formula 65$$

By P_{hb1} all four skills and abilities are marked as not necessary, by Phb2 the first skill or ability is characterized as an active task, etc.

The elements of the above table can be understood as complex numbers (pointer), which contain in their real part (by “1” characterized) all the abilities and skills needed for the solution of a task and contain in the imaginary part (through. “i” characterized) the potentially available, not actual neede abilities and skills. If these complex pointers (P_{hb}i) are multiplied by the vectors of the points Q_{hb} or H_{hb} of the P-space (or H-space), the following complex numbers result for the example of the FIG. 6:

$$\{ complex ω \text{-} values \text{:} \to \begin{matrix}0. \to 1600. i \\ 100. \to 1500. i \\ 300. \to 1300. i \\ 400. \to 1200. i \\ 700. \to 900. i \\ 800. \to 800. i \\ 1000. \to 600. i \\ 1100. \to 500. i \\ 500. \to 1100. i \\ 600. \to 1000. i \\ 800. \to 800. i \\ 900. \to 700. i \\ 1200. \to 400. i \\ 1300. \to 300. i \\ 1500. \to 100. i \\ 1600.\end{matrix} , complex h - values \text{:} \to \begin{matrix}0. \to 1503.67 i \\ 108.048 \to 1395.62 i \\ 294.427 \to 1209.24 i \\ 402.475 \to 1101.2 i \\ 633.516 \to 870.156 i \\ 741.564 \to 762.107 i \\ 927.942 \to 575.729 i \\ 1035.99 \to 467.681 i \\ 467.681 \to 1035.99 i \\ 575.729 \to 927.942 i \\ 762.107 \to 741.564 i \\ 870.156 \to 633.516 i \\ 1101.2 \to 402.475 i \\ 1209.24 \to 294.427 i \\ 1395.62 \to 108.048 \\ 1503.67\end{matrix} \} \qquad Formula 67$$

In the real or imaginary part of the above presented numbers potential values (monetary values or human potential) of different points of the economic space are added (different knowledge and abilities). Therefore complex potential functions are given, which act on an economic space, if the points can be separated in two groups. Since the separation takes place via the request of a task (i.e. via the demand for certain skills and abilities), the potential function decays into a real (necessary knowledge and abilities) and an imaginary section (not actual neede part of skills and abilities). A complex potential represents the complete group of skills and abilities, whose ω- or h-values leads to the same real or imaginary part. Thus each complex number presents an economic potential for a group of points in the economic space. Whereby e.g. the potential of the entire money amount (

$$M = {\sum }_{i}^{L} {m}_{i}$$

or cash flow

$$Ω = {\sum }_{i}^{L} {ω}_{i}$$

) applies to all points of the economic space, a complex potential is only related to certain group of points in this space.

In the past economic theories take into account abilities and skills for humans only conditionally. Their hereby presented desription and the combination with complex potential functions, considers mathematically also the abilities and skills which are not directly needed for tasks. As a result of the consideration of the unnecessary skills and abilities by complex numbers some remarkable economic characteristics arise. There is well know that the amount of a complex number is larger than the pure real or imaginary part. By this characteristic of complex numbers is expressed that the part of skills and abilities, which is economically not necessary for a task, is nevertheless contained in the amount of the absolute number. This is to be demonstrated by the following analysis.

In the FIGS. 9 and 10 are represented the combinational figures of the above Q- and H-distributions in form of their complex numbers in complex number plane.

There are 2^{L}_{^{hb}}=16 points shown in each case in the both diagrams with L_{hb1}=4. Thus 16 combinations for different tasks are to be formed from 4 distinguishable skills and abilities. The points occur in pairs in each case, since the total of the real and imaginary part must result in Qₛᵤₘ or Hₛᵤₘ. Thus the points 600+i1000; and 1000+i600 appear, whereby the total of the real- and imaginary part (1600) marks the ends of the axes. At these points either all necessary abilities are active or inactive, which depend whether the pure real number or imaginary number is given.

The compositions of the potentials in the figures is achieved, as a characteristic from the imaginary part is taken off in each case and added in the real part (and vice versa). Thus the the complex points must follow a straight line, since a modification in one part of the complex number is combined with an exactly equivalent with reverse sign in the other part. The distances of the points on the straight line (potential straight line) are determined by differences of the potential values, thus are the points 600+i 1000; 1000+i 600 adjacent with the points 500+i 1100; 1100+i 500. A large gap between the points of the potential straight line indicates thereupon that no total of the c)-values or h-values is presented in the proximity in the gaps of the points on the potential straight line.

If abilities and knowledge sum up to numbers which are equal in the real as in the imaginary part, these points coincide with same values on the potential straight line and appear in the diagram only as one point, that is why 14 instead of 16 points in the FIG. 9 are to be counted.

A complex potential straight line can be created also from the H-values of cooperating humans. In relation to the above remarks the vector [symbol] _{cop} is given for cooperating humans. From its values the potential straight line can be determined in relation to the above method, as the amount of vector is used as real part or imaginary part of a complex number and the connecting straight line is put between these complex points. With the amount H_{need} is the real part of the application vector well-known. The connecting straight line between these two points (H_{need}+i 0; 0+i H_{need}) represents the potential straight line of the vector [symbol] _{cop}.

The different relations between the potential straight line and this point determine in relation with the difference vector [symbol] which human potential (skills and abilities) are present in the surplus or as lack.

With the introduction of complex potentials the connections between necessary human potential for tasks and available or to looking for human potential is presented in a unique mathematical way. The described methods can be applied in technical, information-processing systems and devices. If the possible data structures of these systems can be described with the above given mathematical methods, it can be also deduced from that fact that the data themselves have characteristics, which correspond to the mathematical method, i.e., economic information potential (possibly the assumption generally applies to the meaning of information in other branches of science) can be described only in a complex representation so completely that structures of the reality are to be entered.

At the end it is to be pointed out here that the formulas of humatics can be represented in general by complex numbers. Thus arises in complex representation for example for the social profit:

D=Y_{hb}−Q_{hb}=T*H Formula 70

With the assumption of a real, constant D-value it results from the above formula by use of the complex human potential H of the FIG. 10 the complex temperature curve T of FIG. 11.

An asolute value/h/of the complex human potential the graph in FIG. 12 is given.

A device implemented method for the determination of a P-Scale in the form of money values of human skills and abilities on the basis of supply and demand with the help of a technical device TEG for electronic data processing for the input, storage, processing and calculation of data is provided according to the present invention. The device is characterized in detail, whereby

1. in TEG a quantity of L distinguishable storage areas a₁, a₂. . . to a_{L} is present,

2. whereby to each storage area an identifier X is assigned, so that L identifier X₁,X₂ . . . to X_{L} are present,

3. whereby with each Identifizierer X is related a classified skill or ability,

4. whereby in each storage area a, a number am, is contained, which corresponds to an offer value in the form of a money value,

5. whereby this offer value ami is to be replaced by a renewed value, whereby

6. in each storage area Lᵢ a number ahbi is contained, which corresponds to an amount of persons, who have the skill or ability Xᵢ,

7. whereby by the calculator of TEG is sequentially calculated after preset time intervals At in each storage area the product of the numbers ami and ahbᵢ,

8. whereby the total of all products ahbi * ami over all given skills or abilities is stored in the memory of the device TEG as summativ monetary supply value Ω,

9. whereby new demand data nhbi, nmi come within the time interval At into the TEG over its input ports,

10. whereby these new data cover a subset of the data, which are contained in memories ai,

11. whereby the on the channels coming in demand values nmi for the by X named skills and abilities are to be used in such a way,

12.that program algorithms can be indicated, with which the preset set ahbi give with the subset nmi new ahbi or by preset ami give with the subset nhbi new ami calculated in such a way that the value Ω is unchanged,

13.with which the available offer values ami alter during the intervals At by the incoming nmi.

The claim 18 describes the establishing of a P-Scale in an electronic data-processing system TEG. The P-Scale is present as quantity of data (as table), whose individual values are sequentially renewed during certain time intervals At. If the data nmi, nhbi of the TEG are made available as supply or demand data by further data-processing systems, the TEG determines sequentially the values of an updated P-Scale (ami, ahbi). For this purpose a quantity of L distinguishable storage areas a1, a2 . . . to a_{L} is present in the TEG. Identifier X are assigned to these storage areas (for example CH-A, EN-A etc.), so that L Identifizierer X₁, X₂ to X_{L} are present. The identifier X are indicating classifiable, human skills or abilities. Classifiable means that the skills or abilities are detectable (checkable) by certain selective criteria such as examinations, tests, competitions etc. In each storage area ai a number ami is contained, which corresponds to a money value of a currency. The number ami is to represent the supply (offer) value of skills or abilities. This is the actual value of the P-Scale by which a skill or ability is offered (for which humans obtain the indicated value). This offer value represents that actual value which has to be replaced by a new detected value. Likewise a number hbᵢ is contained in the memory, which corresponds to a number of humans, with which a certain ability or skill is present. The number hbi represents thus a number, which indicates the frequency, with which certain skills and abilities are indicated with humans.

By the calculator of the TEG it is sequentially calculated during the preset time intervals At the product of the numbers ami and ahbi. Thus this product is for the total of the monetary value of a skill or an ability, which is indicated by X. From the single products ami * ahbi the total 0 can be determined for all skills and abilities and be stored in a memory of the device TEG.

The device TEG has input ports for the data nhbi, nmi whereby these are received during time intervals At. These data cover subsets of the data which are in the TEG already present. In the simplest case only the money value of one ability or one skill is new coming in. The incoming demand values are to be taken into account for the calculation of the new offer values. It is presupposed that there are values Ω, which remain constant during a larger period (thus at least some Δt-intervals). By this presupposition there can be given program algorithm with which by given ahbᵢ the nmᵢ or by given ami the nhbi can be calculated again, so that the constancy of the value 0 remained. In the simplest case a new value (e.g. nm₁) is set into a linear equation (in the place of the product ami* ahb₁ of an identifier) and all further values mi are again calculated, so that the total of all products results in again Ω. Subsequently, the well-known values ahbi, mi can be calculated by the same method (see further below: example language abilities).

The input ports of the device TEG for the data nmᵢ, nhbᵢ are performed as network for the transfer of data. On the external side is given a multiplicity of computers, which supply TEG with new data nmi, nhbi. The external computers are installed e.g. at companies and supply over the network data to TEG (see example language abilities further below).

To claim 20:

If the TEG can process their calculation steps only sequentially, already new data can be present nhbi, nmi during the processing of a function. In this case the TEG can arrange the input data e.g. according to the sequence of input or according to the sequence of sending off and perform the calculations in the sequence of the temporal input.

With the above method supply and demand are used for the determination of the newest values of the P-Sscale. For the evaluation of abilities and skills by money units are used mechanism which are used also in that same manner in free-market economies. Companies ask for abilities and skills, humans offer their abilities and skills. From this interrelation the prices for abilities and skills can be derived. By the interaction of supply and demand the money values for skills and abilities of the P-Scale can be continuously adapted.

The demand value for skills and abilities results in such a way: Since companies know the composition of abilities and skills which they need, companies can send this demand to one (or several) computer. At the same time companies pay for the skills and abilities salaries and wages, i.e. they evaluate the necessary skills and abilities. If companies distribute now the paid salary on the necessary abilities and skills, the demand value for all by companies needed skills and abilities results. In the long run this method applies to the many by wages paid skills and abilities.

The offer value of the abilities and skills is the actual value contained in the P-Scale. If the trainees for example receive the amount of money which is shown in the P-Scale, for each proven skill and ability, it is clear, how the money distribution on the side of supply (at the side of the individuals) for skills and abilities is.

As the demand (the companies) set the offer prices, it determines how many humans decide for the contribution of a certain education. If the companies find e.g. not enough programmer or persons English knowledge, the companies will increase the money values of these abilities. Thus the offer value of these knowledge will become increased, more humans will perform more efforts in these more highly evaluated skills and abilities.

With this balance mechanism between supply and demand in the course of the time a dynamic equilibrium will adjust, which has its specific development in the money values of the P-Scale.

In a simple example is to be demonstrated, how the values of the P-Scale form in the interrelation between supply and demand. For simplification it is assumed a given money amount Q is distributed completely on only two abilities of humans. In the following example the parameters would be in accordance with specifications of the main claim: L=2; X1=CH-A; X2=EN-A; hb1=3; hb2=997; am1=1000; am2=100; Q=102 700 EURO.

The first ability is Chinese speaking (e.g. in the tested form of a basic certificate CH-A) and the second English speaking (in the form of a basic certificate EN-A). From thousand humans 997 have the certificate EN-A and three humans may have the certificate CH-A. As an average value this relation is not to change during a longer period.

If the certificate EN-A is evaluated in the P-Scale with 100 EURO and the certificate CH-A with 1000 EURO, arises as value of the supply for skills and abilities: Ω=997*100+3 *1000=99 700+3000=102 700 EURO. In this situation it is assumed that an employee of a company is taken on. By the company 100 EURO are to be paid for the certificate EN-A and 1 500 EURO for the certificate CH-A. As new value of the supply market arises: Ω=102 700=997*X+3*1 500. From which for the certificate EN-A as new value arises 98.95 EURO. It is to be assumed that during this modified evaluation some additionally humans will decide to learn Chinese. From the increase of the value hb (number of humans, who speak Chinese) an appropriate calculation will show that the offer value for Chinese reduces due to the larger offer quantity.

With the P-Scale is for each composition of skills and abilities of humans the human potential H to determine (see the writings stated above).

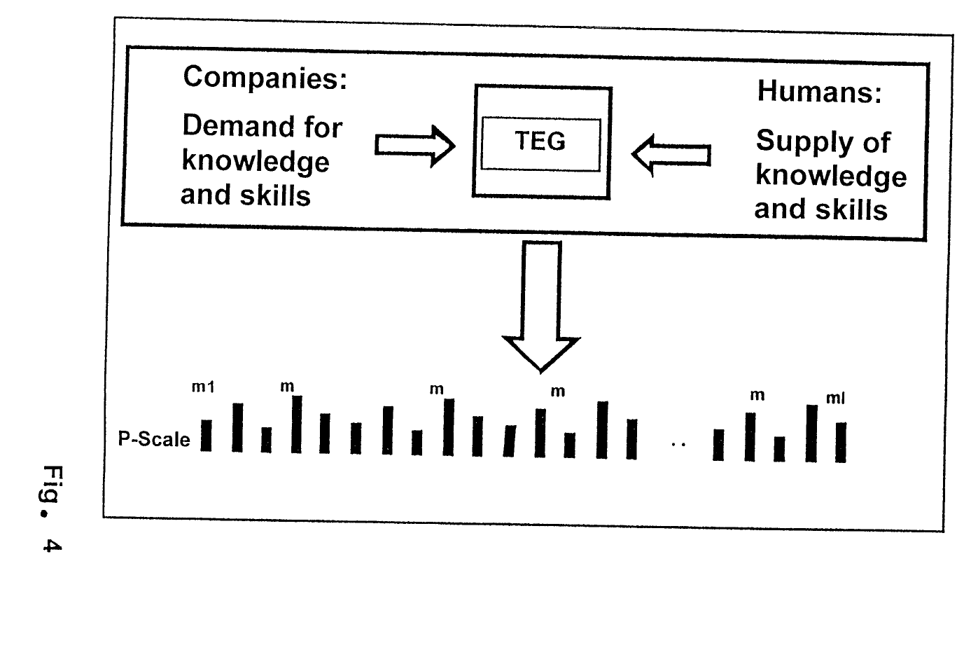

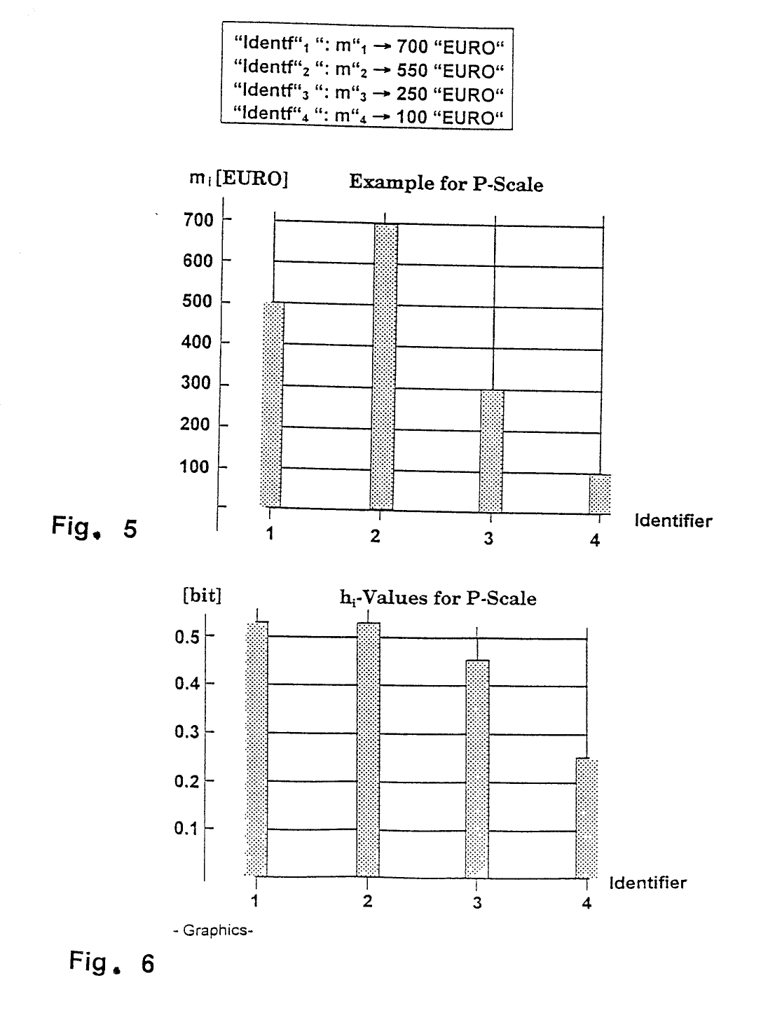

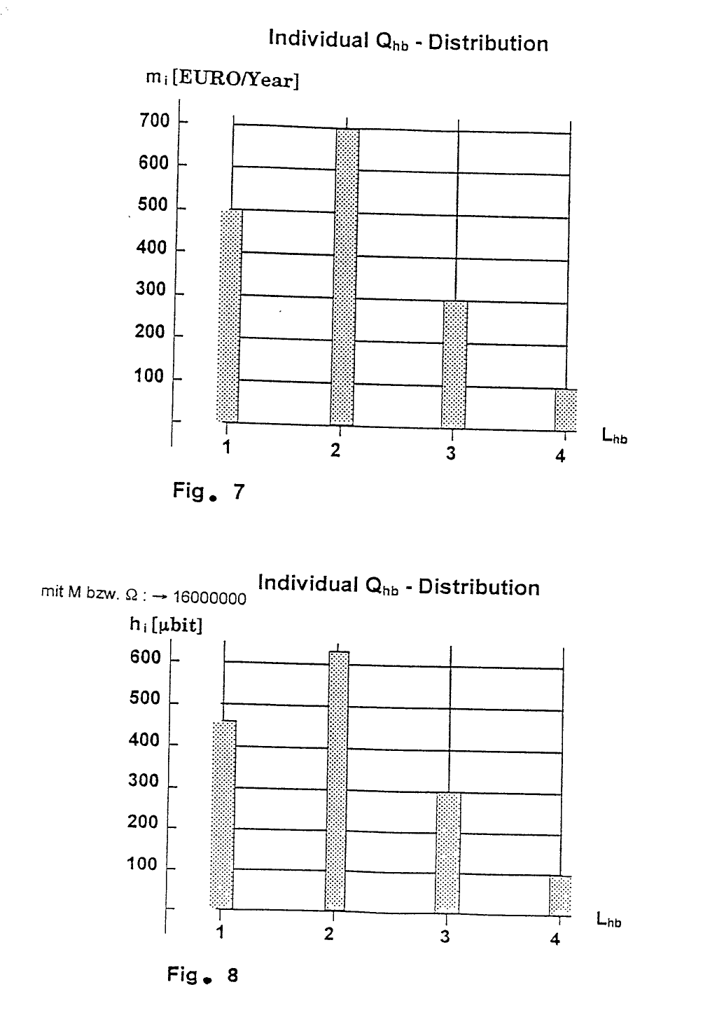

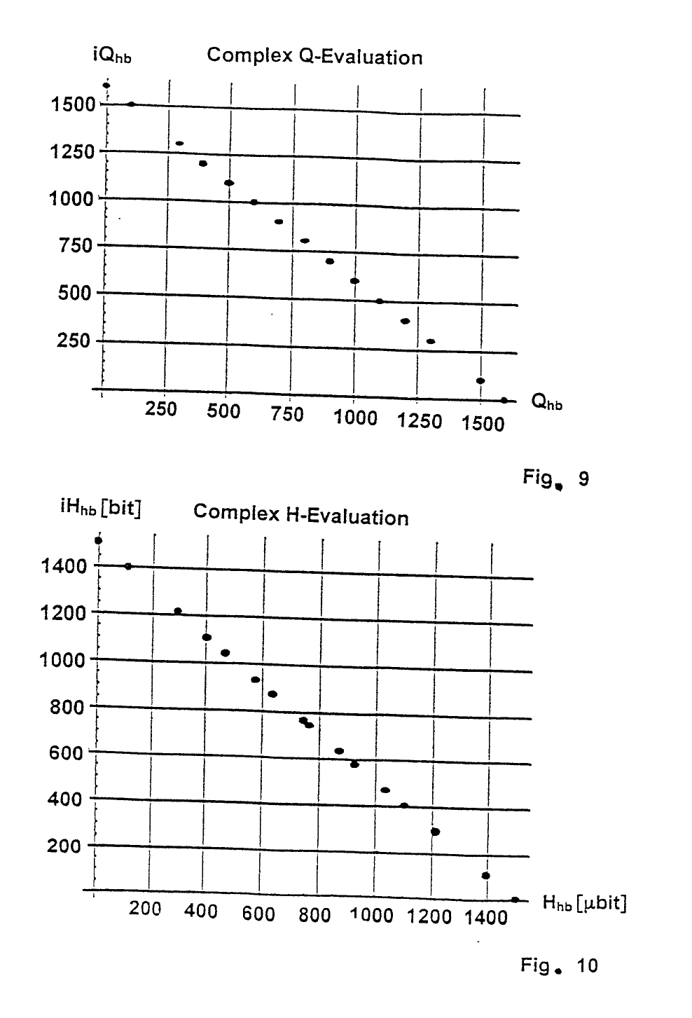

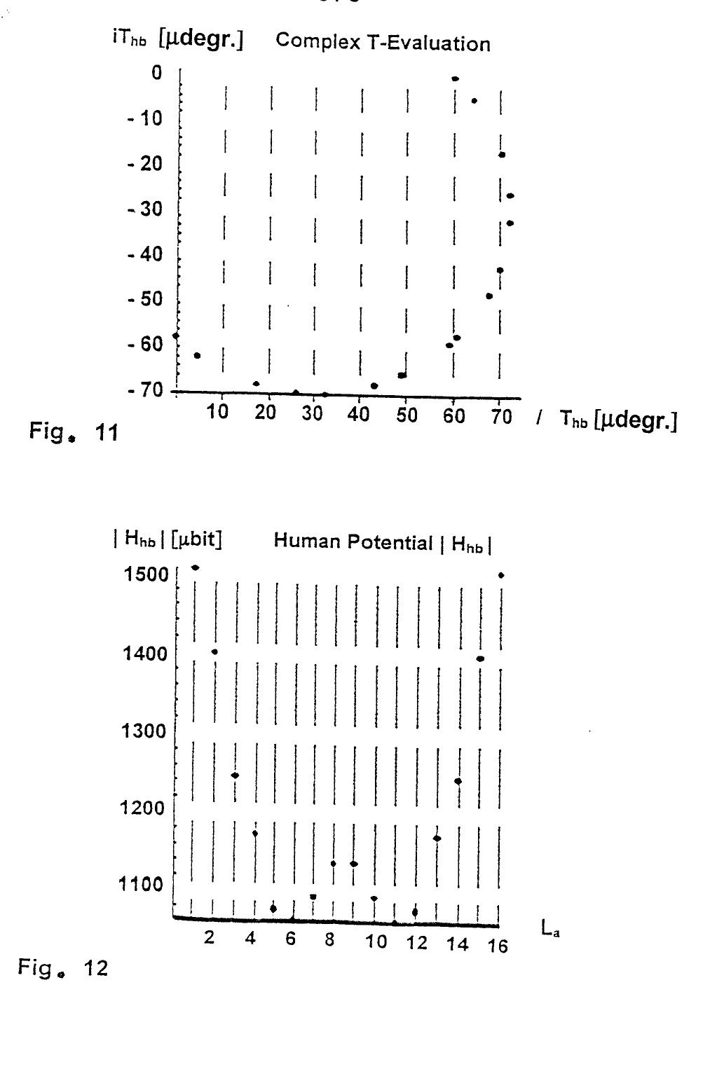

In FIG. 4 is symbolically represented, how in the device TEG a P-Scale (potential scale) is produced. On the left side in the upper small box companies are named as the demand side, in the right side humans are named as providers of skills and abilities. Into the device (suggested by arrows) data run. The data appear, if for example companies take on employees and send to the device TEG, which payments they spend for the demanded skills and abilities. In the device TEG the data are linked and calculated in such a way that the values mi of the P-Scale in the lower part of the diagram are determined.

### COMMERCIAL APPLICABILITY

The invented method is in particular suitable for determining automatically economic data like “economic potential V” and “economic temperature T” by means of technical devices. With these quantities deeper, economic relations are revealed which were not visible so far, with which new evaluations of micro as well as macro economical processes and new solutions are possible, e.g. for the removal of unemployment. The usefulness of the method consists in particular of the fact that today's incomparable economic situations of different persons or enterprises can be compared.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim:

1. A method for the measurement of economic potentials V and economic temperatures T used under help of a technical device TEG for the input, storage and processing of data for the evaluation of economic processes, wherein the technical device TEG contains electronic components for storing and calculating data, in TEG a quantity L of distinguishable storage areas a1, a2 . . . aL are given, whereby to each storage area ai at least is assigned one identifier X, so that at minimum L identifier X1, X2 . . . to XL are given,
whereby by each Identifier X classifiable, economic goods P are additionally marked as products, services, human abilities or knowledge,
whereby at least to one storage area ai a number mi is assigned, which is related to a money amount in units of a currency whereby this money amount mi is assigned to a good P,
whereby the values of mi are data which are evaluated from reference data of market demand and market supply,
whereby in the device TEG the following calculation steps are executed over L identifier at certain times t1 to tn:
from the L numbers mi is calculated the total Nsum,
to each number mi is calculated a quotient pi from the number mi to the total Nsum, pi=mi/Nsum,
to each pi a logarithmic value Id pi is determined and by pi multiplied, to become L numbers of Lgi,
from L values Lgi is by addition determined the total V, which is negative,
whereby in the case of multiplication of the value V with −1 are given positive values of V and thus positive logarithmic numbers are given,
whereby the logarithmic numbers in accordance with their appearance at points of time sequences ti to tn determine a sequence of economic potentials V, which can be directly displayed at the device TEG or can be transmitted to a remote data process device,
whereby economic potentials of goods P become comparable, if the logarithmic numbers are equally determined and counted in identical characteristic units.

2. A method according to claim 1, wherein in one arrangement of the method the economic temperature T is determined as quotient from the total Nsum divided by the economic potential V, T=Nsum/V.

3. A method according to claim 1, wherein in that:
to the by L identified storage areas ai additional to the mi a further number hbi is assigned, which corresponds to an amount of humans, which possess the by Xi indicated skills and abilities,
whereby by the processor of the TEG in sequential time intervals □t or at optional time points t1 to tn products aωi of pairs of numbers ami, ahbi are evaluated by aωi=ami*ahbi,
whereby the total of all L products aωi is calculated as summativ monetary supply value Ωin the device TEG,
whereby into the TEG over data inputs to the □t or the t1 to tn at least one new number bhbj or bmj is coming in for a pair of values bhbj, bmj as demand data for a by Xj defined skill or ability,
whereby at least one pair of data ahbi, ami is replaced by the pair of data bhbj, bmj, so that a new product bωj=bmj*bhb results,
whereby all not replaced products aωi=ami*ahbi are to be modified with their ami in such a way that the total Ω remains constant by using the new product bωi=bmi*bhbi.

4. A method according to claim 1, wherein in that the L identifier La, Lc are divided at least in two groups, whereby a part of the L of storage places a1, a2 . . . to aL are assigned to the group La and another part to the group Lc thus in a TEG with V, Va, Vc can be determined at least three values for the distinguishable groups of identifiers L, La, Lb, which are counted in logarithmic quantities.

5. A method according to claim 3, wherein in that the Lgi, mi, T or further values, which are given by use of Lgi, mi, T are available in devices, which serve for the composition of accounting data or for controlling analyses of companies or for the use of national economic data survey thus that are computational combination of the values Lgi, mi, T with further values of different accounting data or controlling analyses of companies or of national economic data survey are possible.

6. A method according to claim 4, wherein in that the Lgi, mi, T or further values, which are given by use of Lgi, mi, T are available in devices, which serve for the composition of accounting data or for controlling analyses of companies or for the use of national economic data survey thus that are computational combination of the values Lgi, mi, T with further values of different accounting data or controlling analyses of companies or of national economic data survey are possible.

7. A method according to claim 1, wherein in that the calculation steps in the device TEG can take place in different devices TEG-A1 to TEG-AX in different memories R-A1 to R-AX at different times, so that different values V-A1 to V-AX are given, which are formed in the devices TEG-A1 to TEG-AX from the values L-A2 to L-AX, X-A1 X-AX with the related storage spaces ai and values mi, whereby these values altogether or in parts are transmitted to one of the devices TEG-A1 to TEG-AX and there are stored for further processing in a joint memory R-U, whereby the values from the devices in the memory R-U are arranged to groups R1 to Ri on which further calculation steps are applied for achieving uniformity of the values V-A1, V-AX.

8. A method according to claim 1, wherein in that the in two different devices or memory elements TEG-A1 to TEG-A2 calculated values Nsum-A1, Nsum-A2 give the value k by dividing Nsum-A1 by Nsum-A2, whereby in the device TEG-A1 the value V is given by V-A1 and in TEBG-A2 the value V is given by V-A2, whereby in the device TEG-A1 the value V-A2 is calculated by the available value V-A1 by use of the value k, whereby in the device TEG-A2 the value V-A1 is calculated by the value V-A2 by use of the value k.

9. A method according to claim 1, wherein in that the device TEG is a reader, which reads data over an optical reading system automatically from a data carrying medium DM, whereby the L data on the medium DM are present in the form of a table with L columns or with L lines, whereby to each of the L line or column places a value of money amount mi is assigned, whereby the device TEG calculates from the read in table data the values V, T.

10. A method according to claim 1 wherein in that the device TEG is a for humans transportable device, which contains a microprocessor, with which value V, T can be calculated, whereby the transportable device can transfer the L identifier X and further data like mi or values V, T over different, technically usual interfaces to terminals, transmitting devices, radio towers, satellites for connection to further technical devices.

11. A method according to claim 1, wherein in that in a device TEG-A, which is similar or identically constructed to the device TEG, a certain coding for each of the identifier X is present and this coding is used by further devices TEG-A1 . . . TEG-Ax, so that to the same classes of economic goods and performances in the devices TEG-A, TEG-A1 to TEG-Ax the same codings for identifier X are assigned to.

12. A method according to claim 1, wherein in that in a device TEG-Cal, which is similar or identically constructed to the device TEG, an relation from identifier X to technical units Ui is present, whereby to the units mU are assigned money values Ui, whereby the technical units Ui are suitable, to assign to classes of economic goods and services the measure weight gi, with which the device TEG-Cal can assign to all coded identifier X money values mi by use of measure weight gi and the money values mU, with which calibrated values V and T in the device TEG-Cal result, with which classes of goods and services are comparable in their V-values and T-values.

13. A method according to claim 1, wherein in that several devices TEG-XY are connected with one device TEG-Cal by a communications network for data exchange, with which the devices TEG-XY can its values V, T compare with values in TEG-Cal ore be able to transform it in relation to different reference values.

14. A method according to claim 1, wherein in that L identifier X are indicated by a first technical device TEG-1 at a first place OA-1, whereby the L numbers mi are indicated in a further technical device TEG-2 at a second place OA-2 and are present there, whereby in one of the devices TEG-1 or TEG-2 or a further device TEC-3 the values V, T are determined from the data of the TEG-1 or TEG-2.

15. A method according to claim 1, wherein in that the identifier X in a company are assigned to that goods which are given as input goods and are needed for the production of the sellable products Y or which can be determined as the sales products at the output side of a company.

16. A method according to claim 1, wherein in that in a device TEG-Pscl in a memory R-Psclm are present L identifier for each human ability or skill with at least L storage spaces ai, whereby each of the storage spaces a1, a2 . . . to aL, contain a money value m1 m2 . . . mL, which is assigned to an economic good, whereby also a value Lgi is assigned to each identifier, which is at disposal by data communication for other devices.

17. A method according to claim 1, wherein in that the values Lgi, mi or further values, which are determined in accordance with the claimed method, are used in devices for automatic process regulation or process control.

18. A method according to claim 1, wherein in that the values hi, mi or further values, which determined in accordance with the claimed method, are grouped in relation to task requirements, so that to certain identifier assigned abilities and skills are assigned to certain tasks.

19. A method for the determination of a P-Scale in the form of money values of human skills and abilities on the basis of supply and demand with the help of a technical device TEG for electronic data processing for the input, storage, processing and calculation of data, characterized in that
in TEG a quantity of L distinguishable storage areas a₁, a₂ . . . to a_{L} is present,
whereby to each storage area an identifier X is assigned, so that L identifier X₁, X₂ . . . to X_{L} are present,
whereby with each identifier X is determined a classified human skill or ability,
whereby in each storage area aᵢ a number amᵢ is contained, which corresponds to an offer value in the form of a money value,
whereby this offer value ami is to be replaced by a renewed value,
whereby in each storage area Lᵢ a number ahbᵢ is contained, which corresponds to an amount of persons, who have the skill or ability Xᵢ,
whereby by the calculator of TEG is sequentially calculated after preset time intervals Δt in each storage area the product of the numbers ami and ahbᵢ,
whereby the total of all products ahbi*ami over all given skills or abilities is stored in the memory of the device TEG as summative monetary supply value Ω,
whereby new demand data nhbᵢ, nmᵢ come in within the time interval Δt into the TEG over its input ports,
whereby these new data cover a subset of the data ahbi, ami,
whereby the by the channels coming in demand values nmi for the by X named skills and abilities are to be used in such a way,
that program algorithms can be indicated, with which the preset set ahbi give with the subset nmi new ahbi or by preset ami give with the subset nhbi new ami calculated in such a way that the value Ω is unchanged,
with which the available offer values ami alter during the intervals Δt by the incoming nmi.

20. A method according to claim 19, wherein in that the input ports for the data nmi, nhbi of the device TEG are performed as a network for the transfer of data, whereby on the one side is present the device TEG and on the other side is present a multiplicity of external computers, whereby the external computers supply to the TEG the new data nmi, nhbi.

21. A method according to claim 19 wherein in that in the TEG are available computing algorithms, which sort and calculate the input data in relation to time characterisitcs.
